(19) United States
(12) Patent Application Publication
(10) Pub. No.: US 2014/0247623 A1
(43) Pub. Date: Sep. 4, 2014

(54) REACTOR, REACTOR-USE COIL COMPONENT, CONVERTER, AND POWER CONVERTER APPARATUS

(71) Applicants: Sumitomo Electric Industries, Ltd., Osaka-shi (JP); AutoNetworks Technologies, Ltd., Yokkaichi-shi (JP); Sumitomo Wiring Systems, Ltd., Yokkaichi-shi (JP)

(72) Inventor: Kazuhiro Inaba, Osaka-shi (JP)

(73) Assignees: SUMITOMO ELECTRIC INDUSTRIES, LTD., Osaka-shi (JP); AUTONETWORKS TECHNOLOGIES, LTD., Yokkaichi-shi (JP); SUMITOMO WIRING SYSTEMS, LTD., Yokkaichi-shi (JP)

(21) Appl. No.: 14/350,036

(22) PCT Filed: Sep. 25, 2012
(86) PCT No.: PCT/JP2012/074508

§ 371 Date: Apr. 4, 2014

(30) Foreign Application Priority Data
Oct. 6, 2011 (JP) 2011-222308
Aug. 13, 2012 (JP) 2012-179584

(51) Int. Cl. H01F 27/28; H02M 7/44; H02M 3/158

(52) U.S. Cl. CPC H01F 27/2876; H02M 3/158; H02M 7/44
USPC 363/13; 336/61; 323/282

(57) ABSTRACT

A reactor 1A of the present invention includes a sleeve-like coil 2, a magnetic core 3 that is disposed inside and outside the coil 2 to form a closed magnetic path, and a case 4A that stores the coil 2 and the magnetic core 3. At least part of the magnetic core 3 (herein an outer core portion 32 provided on the outer circumference side of the coil 2) is formed by a composite material that contains magnetic substance powder and resin. At least part of the outer circumference of the coil 2 is covered by a resin mold portion 21 that is formed by an insulating resin, whereby the shape of the coil 2 is retained. A heat dissipating pedestal portion 5A that forms at least part of the case 4A and that is formed by a non-magnetic metal material is integrally retained with the coil 2 by the resin forming the resin mold portion 21. Thanks to the heat dissipating pedestal portion 5A, the coil 2 can be disposed in the case 4A in a stable manner, and furthermore the heat of the coil 2 can be efficiently transferred to the installation target. Accordingly, the reactor 1A has an excellent heat dissipating characteristic.

### TECHNICAL FIELD

The present invention relates to a reactor used as a constituent component of an in-vehicle DC-DC converter mounted on a vehicle such as a hybrid vehicle or of a power converter apparatus, a reactor-use coil component, a converter including the reactor, and a power converter apparatus including the converter. In particular, the present invention relates to a reactor with excellent heat dissipating characteristic.

### BACKGROUND ART

A reactor is one of the components of a circuit that performs a voltage step up or step down operation. For example, Patent Literature 1 discloses a reactor that is used for a converter mounted on a vehicle such as a hybrid vehicle. The reactor includes a sleeve-like coil, a magnetic core disposed inside and outside the coil, and a bottomed sleeve-like case storing the coil and the magnetic core. Patent Literature 1 discloses the mode in which the portion of the magnetic core that covers the outer circumferential face and end faces of the coil is made of a composite material of magnetic substance powder and resin.

The reactor used as an in-vehicle component is generally used as being fixed to an installation target such as a cooling base, such that the coil and the like that produce heat when being energized are cooled. The case is made of a material exhibiting excellent thermal conductivity, such as aluminum (see paragraph [0039] and others in the specification of Patent Literature 1). The case is fixed such that its outer bottom face is in contact with the installation target, to be used as a heat dissipation path.

### CITATION LIST

### Patent Literature

Patent Literature 1: Japanese Unexamined Patent Publication No. 2011-124310

### SUMMARY OF INVENTION

### Technical Problem

It is desired to further enhance the heat dissipating characteristic of a reactor in which at least part of the magnetic core is made of the composite material containing the above-described resin.

The resin contained in the composite material is generally smaller in thermal conductivity than the metal forming the case, and hence its heat dissipating characteristic is poor. Accordingly, in the mode in which the outer circumferential face and end faces of the coil that produces heat when being energized are covered by the composite material, the heat of the coil tends to accumulate. In the situation where a mold product made of the composite material is prepared and the mold product is assembled to the coil, part of the outer circumferential face of the coil can be exposed outside the composite material. However, because of the presence of the resin in the mold product, the heat dissipating characteristic of the mold product is poor as compared to the magnetic core that is substantially made of metal (e.g., a lamination product of electromagnetic steel sheets). Accordingly, it is desired to improve the heat dissipating characteristic also in the situation where the mold product made of the composite material is included.

In order to improve the heat dissipating characteristic, for example, the coil may be stored in the case such that the axis of the coil becomes parallel to the outer bottom face of the case, which is in contact with the installation target such as a cooling base. With this storage mode (hereinafter referred to as the horizontal storage mode), as compared to the mode in which the coil is stored in the case such that the axis of the coil becomes perpendicular to the outer bottom face of the case (hereinafter this storage mode is referred to as the vertical storage mode), the region in which the distance to the installation target is short becomes greater in the outer circumferential face of the coil. Thus, the heat dissipating characteristic can be enhanced.

However, when the coil is in a shape with a curved surface such as a cylindrical shape, though the coil can be formed with ease, it is difficult to dispose the coil in the case in a stable manner, particularly in the horizontal storage mode. When the coil is disposed in an unstable manner, an improvement in the heat dissipating characteristic may not be fully achieved. Further, in the horizontal storage mode, since it is difficult to dispose the coil in a stable manner, a reduction in productivity of the reactor is invited.

Accordingly, an object of the present invention is to provide a reactor with an excellent heat dissipating characteristic. Further, another object of the present invention is to provide a reactor-use coil component with which a reactor with an excellent heat dissipating characteristic can be obtained. Still further, still another object of the present invention is to provide a converter including a reactor with an excellent heat dissipating characteristic, and a power converter apparatus including the converter.

### Solution to Problem

The present invention achieves the objects by allowing a member forming part of a case to serve as a heat dissipation path and a coil to be integrally retained by resin.

The reactor of the present invention is a reactor including: a sleeve-like coil; a magnetic core that is disposed inside and outside the coil to form a closed magnetic path; and a case that stores the coil and the magnetic core. At least part of the magnetic core is formed by a composite material that contains magnetic substance powder and resin. The reactor of the present invention further includes: a resin mold portion that is formed by an insulating resin and that covers at least part of an outer circumference of the coil to retain a shape of the coil; and a heat dissipating pedestal portion that is formed by a non-magnetic metal material and that is integrally retained with the coil by the resin forming the resin mold portion to form at least part of the case.

In the present invention, the “heat dissipating pedestal portion forming at least part of the case” refers to the case, which includes a bottom portion and a wall portion provided to stand from the bottom portion, satisfying any of the following conditions: the bottom portion or the wall portion and the heat dissipating pedestal portion are in surface-contact with each other; the heat dissipating pedestal portion is fixed to the bottom portion or the wall portion via a fixing member such as a fastening member, e.g., an adhesive agent or bolts; the bottom portion or the wall portion and the heat dissipating pedestal portion are fixed to each other by being engaged with each other; and the heat dissipating pedestal portion itself structures the bottom portion or the wall portion.

With the reactor of the present invention, (1) the heat dissipating pedestal portion made of a metal material that generally exhibits excellent thermal conductivity is included; (2) the heat of the coil can be easily transferred to the heat dissipating pedestal portion because the heat dissipating pedestal portion is integrated with the coil by the resin mold portion; (3) the heat transferred to the heat dissipating pedestal portion can be efficiently transferred to the installation target on which the case is installed, because the heat dissipating pedestal portion forms part of the case; and (4) the heat of the coil can be efficiently transferred to the installation target, because the coil can be disposed in the case in a stable manner as compared to the situation where the coil is directly disposed on the bottom portion of the case. Thanks to these points, the reactor of the present invention exhibits an excellent heat dissipating characteristic.

Further, with the reactor of the present invention, thanks to the resin mold portion: (1) the shape of the coil can be maintained, whereby the coil is not expanded or compressed during assembly and hence the coil can be handled with ease; and (2) the coil and the heat dissipating pedestal portion are integrated, whereby the number of assembled components is small and the assembly steps can be reduced. Further, employing injection molding or the like, the resin mold portion can be molded with ease even in a complicated shape, i.e., covering at least part of the outer circumference of the coil, and integrating the heat dissipating pedestal portion. In addition, by forming the heat dissipating pedestal portion into an appropriate shape, the coil can be disposed in a stable manner, and the stable manner can be maintained. For example, in the situation where the composite material is formed using the case as a mold assembly and by cast molding, the position of the coil can be prevented from shifting in the case while the mixture as the composite material is packed into the case. Further, since the heat dissipating pedestal portion is independent of the case during manufacture, it can be easily molded into any shape with ease, e.g., into a shape conforming to the shape of the coil. Accordingly, as compared to the situation where a fitting groove conforming to the shape of the coil is formed at the inner bottom face of the case, the reactor of the present invention can employ the case of a simpler shape, and hence excellent manufacturability of the case also is exhibited. Thanks to these points, the reactor of the present invention exhibits excellent productivity also.

In addition, since the resin mold portion is made of an insulating resin, insulation between the coil and the magnetic core or insulation between the coil and the heat dissipating pedestal portion can be enhanced by the insulating resin interposed between the coil and the magnetic core or between the coil and the heat dissipating pedestal portion.

As a constituent component of the reactor of the present invention, the following reactor-use coil component of the present invention can be suitably used. The reactor-use coil component of the present invention is used as a constituent component of a reactor, which includes a sleeve-like coil, a magnetic core disposed inside and outside the coil to form a closed magnetic path, and a case storing the coil and the magnetic core. At least part of the magnetic core is formed by a composite material containing magnetic substance powder and resin. The reactor-use coil component is structured by a sleeve-like coil, a resin mold portion that is made of an insulating resin, and that covers at least part of the outer circumference of the coil to retain the shape of the coil, and a heat dissipating pedestal portion that is formed by the non-magnetic metal material and that is integrally retained with the coil by the resin forming the resin mold portion to form at least part of the case.

As described above, the reactor-use coil component of the present invention includes a heat dissipating pedestal portion with excellent thermal conductivity, on which the coil can be disposed in a stable manner. Further, the coil and the heat dissipating pedestal portion are integrated with each other by the resin mold portion. In this structure, since the reactor-use coil component of the present invention is disposed in the reactor-use case, a reactor with an excellent heat dissipating characteristic can be obtained. Further, the reactor-use coil component of the present invention can be handled with ease as described above, and can be easily disposed in a reactor-use case also. Hence, the reactor-use coil component can also contribute toward improving the productivity of the reactor with an excellent heat dissipating characteristic.

According to one aspect of the reactor of the present invention, the coil includes a juxtaposed pair of sleeve-like coil elements, and the magnetic core is formed by the composite material. Further, as one mode of the reactor-use coil component of the present invention, the magnetic core may be used for a reactor made of the composite material, and the coil includes a juxtaposed pair of sleeve-like coil elements.

In the mode noted above, since a pair of coil elements is included, the length of the coil in the axial direction can be shortened even when the number of turns is great, and a reduction in size can be achieved. Further, in the foregoing mode, though the entire magnetic core is formed by the composite material, an excellent heat dissipating characteristic can be obtained thanks to provision of the heat dissipating pedestal portion. Further, in the mode noted above, a magnetic core of various magnetic characteristics can be easily manufactured by varying the type or content of the magnetic substance powder, and there is great flexibility in the shape of the magnetic core.

According to one aspect of the reactor of the present invention, the coil includes the sleeve-like coil element by one in number, and in the magnetic core, at least part of a portion disposed on an outer circumferential side of the coil element is formed by the composite material, and in the outer circumference of the coil element, a portion covered by the composite material is covered by the resin forming the resin mold portion. Further, as one mode of the reactor-use coil component of the present invention, the coil may include the sleeve-like coil element by one in number. In the outer circumference of the coil element, the portion covered by the composite material is covered by the resin forming the resin mold portion. This reactor-use coil component is used for a reactor in which, in the magnetic core, at least part of the portion disposed on the outer circumferential side of the coil element is made of the composite material.

The mode noted above can provide a reactor being small in size, because the coil element is included by one in number. Further, in this mode, though at least part of the outer circumference of the coil is covered by the composite material, an excellent heat dissipating characteristic is exhibited thanks to provision of the heat dissipating pedestal portion.

According to the one aspect of the reactor and the coil component for the reactor of the present invention, in the heat dissipating pedestal portion, at least part of a region covered by the resin mold portion is subjected to a surface roughening treatment.

By the surface roughening treatment, the contact area between the heat dissipating pedestal portion and the resin forming the resin mold portion can be increased, whereby adhesion between them can be enhanced. Accordingly, in this mode, the coil and the heat dissipating pedestal portion are strongly joined to each other via the resin forming the resin mold portion. Thus, the heat of the coil can be easily transferred to the heat dissipating pedestal portion, and an excellent heat dissipating characteristic is exhibited. Further, thanks also to the fact that the surface area of the heat dissipating pedestal portion itself is increased by the surface roughening treatment, this mode provides an excellent heat dissipating characteristic.

According to one aspect of the reactor and the coil component for the reactor of the present invention, the heat dissipating pedestal portion has a fixing hole with which a fastening member for fixing the heat dissipating pedestal portion to the case is screwed.

In the mode noted above, the heat dissipating pedestal portion can be surely fixed to the case, and the heat of the coil transferred through the heat dissipating pedestal portion can be efficiently transferred to the installation target outside the case. Thus, an excellent heat dissipating characteristic is obtained. Further, in this mode, the position of the coil in the case will not shift for a long period.

According to one aspect of the reactor and coil component for the reactor of the present invention, the case and the heat dissipating pedestal portion each include an engaging portion engaging with each other.

In the mode noted above, without the necessity of using any fastening members such as bolts, the heat dissipating pedestal portion can be positioned in the case. Thus, excellent productivity of the reactor is achieved. Further, in the mode noted above, the heat of the coil transferred through the heat dissipating pedestal portion can be efficiently transferred to the installation target outside the case. Thus, an excellent heat dissipating characteristic is obtained.

According to one aspect of the reactor of the present invention, at the case, a pedestal groove into which at least part of the heat dissipating pedestal portion is fitted is formed. Further, as one mode of the reactor-use coil component of the present invention, at least part of the heat dissipating pedestal portion is fitted into the pedestal groove formed at the case.

In the mode noted above, since at least part of the heat dissipating pedestal portion is fitted into the case, the heat dissipating pedestal portion can be positioned without the necessity of using any fastening members such as bolts, as described above. Thus, excellent productivity of the reactor is exhibited, and an excellent heat dissipating characteristic is also obtained. Further, since the shape of the heat dissipating pedestal portion is simple, the shape of the pedestal groove can also be in a simple shape. Thus, the case can be formed easily.

According to one aspect of the reactor of the present invention, the reactor includes a lid portion that covers an opening portion of the case; and a lid-side pedestal portion that is formed by a non-magnetic metal material and that is integrally retained with the coil by the resin forming the resin mold portion, the lid portion being attached to the lid-side pedestal portion. Further, as one mode of the reactor-use coil component of the present invention, a lid-side pedestal portion may be further included. The lid-side pedestal portion may be made of a non-magnetic metal material and integrally retained with the coil by the resin forming the resin mold portion. To the lid-side pedestal portion, a lid portion covering an opening portion of the case may be attached.

In the mode noted above, since the lid-side pedestal portion is further included in addition to the heat dissipating pedestal portion, the lid-side pedestal portion and the lid portion can also be used as the heat dissipation path, whereby a further excellent heat dissipating characteristic is obtained. Further, since the opening portion of the case is covered by the lid portion, protection from the external environment and mechanical protection to the stored item in the case can be achieved.

According to one aspect of the reactor of the present invention, in the magnetic core, an inner core portion disposed inside the coil is integrally retained with the coil by the resin forming the resin mold portion. Further, as one mode of the reactor-use coil component of the present invention, in the magnetic core included in the reactor, an inner core portion disposed inside the coil may be integrally retained with the coil by the resin forming the resin mold portion.

In the mode noted above, since part of the magnetic core, in addition to the coil, is integrated by the resin mold portion, excellent assemblability of the reactor is achieved.

As one mode of the reactor of the present invention, the coil may be stored in the case such that the axis of the coil is parallel to the outer bottom face of the case. Further, as one mode of the reactor-use coil component of the present invention, the coil may be attached to the heat dissipating pedestal portion by the resin mold portion, such that the axis of the coil is parallel to the outer bottom face of the case when the coil is stored in the case included in the reactor.

In the mode noted above, the reactor in the horizontal storage mode can be structured. In the outer circumferential face of the coil, the region where the distance to the installation target is short can be fully widely secured. Thus, an excellent heat dissipating characteristic is achieved. Further, as compared to the vertical storage mode, the volume can be reduced easier. Thus, the coil component (the reactor-use coil component of the present invention) in which the coil and the heat dissipating member are integrated by the resin mold portion can be easily stored in the case. Hence, excellent assemblability is exhibited.

According to one aspect of the reactor and the coil component for the reactor of the present invention, the heat dissipating pedestal portion includes a supporting face along the outer circumferential face of the coil.

Since the wider region of the outer circumferential face of the coil is disposed in close proximity to the heat dissipating pedestal portion by the supporting face, the heat of the coil can be transferred to the heat dissipating pedestal portion further efficiently. Thus, this mode provides an excellent heat dissipating characteristic. Further, since the resin forming the resin mold portion is present by a uniform thickness between the outer circumferential face of the coil and the supporting face of the heat dissipating pedestal portion, this mode also provides an excellent insulation performance.

The converter of the present invention includes the reactor of the present invention. The power converter apparatus of the present invention includes the converter of the present invention.

The converter of the present invention or the power converter apparatus of the present invention includes the reactor of the present invention exhibiting an excellent heat dissipating characteristic. Accordingly, the converter of the present invention or the power converter apparatus of the present invention has an excellent heat dissipating characteristic, and can be used as an in-vehicle component, particularly a constituent component of a converter or as a constituent component of a power converter apparatus.

### Advantageous Effects of Invention

The reactor of the present invention has an excellent heat dissipating characteristic. With the reactor-use coil component of the present invention, a reactor with an excellent heat dissipating characteristic can be obtained.

### BRIEF DESCRIPTION OF DRAWINGS

FIG. 1 (A) is a schematic perspective view of a reactor according to a first embodiment; and FIG. 1 (B) is a cross sectional view taken along (B)-(B) in FIG. 1 (A).

FIG. 2 is an exploded perspective view of the reactor according to the first embodiment.

FIG. 3 (A) is a schematic perspective view of a constituent member retained by a resin mold portion in a coil component included in the reactor according to the first embodiment; and FIG. 3 (B) is a schematic perspective view of an inner core portion.

FIG. 4 is a schematic perspective view of the reactor according to a second embodiment.

FIG. 5 (A) is a schematic perspective view of a coil component included in the reactor according to the second embodiment; and FIG. 5 (B) is a cross sectional view taken along (B)-(B) in FIG. 4 (A).

FIG. 6 (A) is a schematic perspective view of a reactor according to a third embodiment; and FIG. 6 (B) is a schematic perspective view of a coil component included in the reactor.

FIG. 7 is a schematic perspective view showing a coil, an inner core portion, and a heat dissipating pedestal portion included in the reactor according to a fifth embodiment.

FIG. 8 is a schematic perspective view showing the coil, the inner core portion, and the heat dissipating pedestal portion included in the reactor according to the fifth embodiment, showing an example in which the end face shape of the coil is different.

FIG. 9 is a schematic configuration diagram schematically showing a power supply system of a hybrid vehicle.

FIG. 10 is a schematic circuit diagram showing one example of a power converter apparatus of the present invention including the converter of the present invention.

### DESCRIPTION OF EMBODIMENTS

In the following, a specific description will be given of embodiments of the present invention with reference to the drawings. Throughout the drawings, identical reference signs denote identically named elements.

### First Embodiment

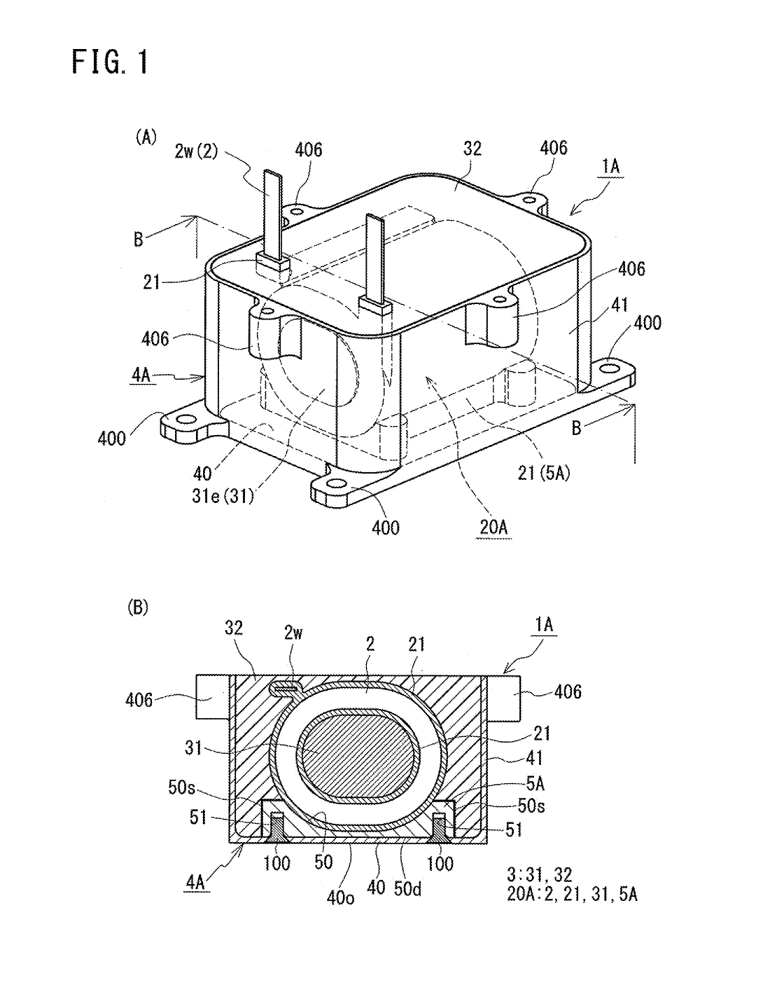

With reference to FIGS. 1 to 3, a description will be given of a reactor 1A according to a first embodiment. The reactor 1A includes a coil 2 mainly made of one sleeve-like coil element made of a spirally wound wire 2w, and a magnetic core 3 disposed inside and outside the coil 2 to form a closed magnetic path. The coil 2 and the magnetic core 3 are stored in a bottomed sleeve-like case 4A. Representatively, the reactor 1A is used having the case 4A installed on an installation target such as a cooling base. The magnetic core 3 includes a columnar inner core portion 31 disposed in the coil 2, and an outer core portion 32 disposed on the outer circumferential side of the coil 2. Herein, the outer core portion 32 is made of a composite material containing magnetic substance powder and resin. The case 4A is a box-like element in which a bottom portion 40 and a wall portion 41 are integrally molded. The reactor 1A is characterized by provision of a coil component 20A in which the coil 2 and a heat dissipating pedestal portion 5A, which is fixed to the case 4A to form part of the bottom portion 40 of the case 4A, are integrally retained by a resin mold portion 21. In the following, a detailed description will be given of each structure.

(Coil Component)

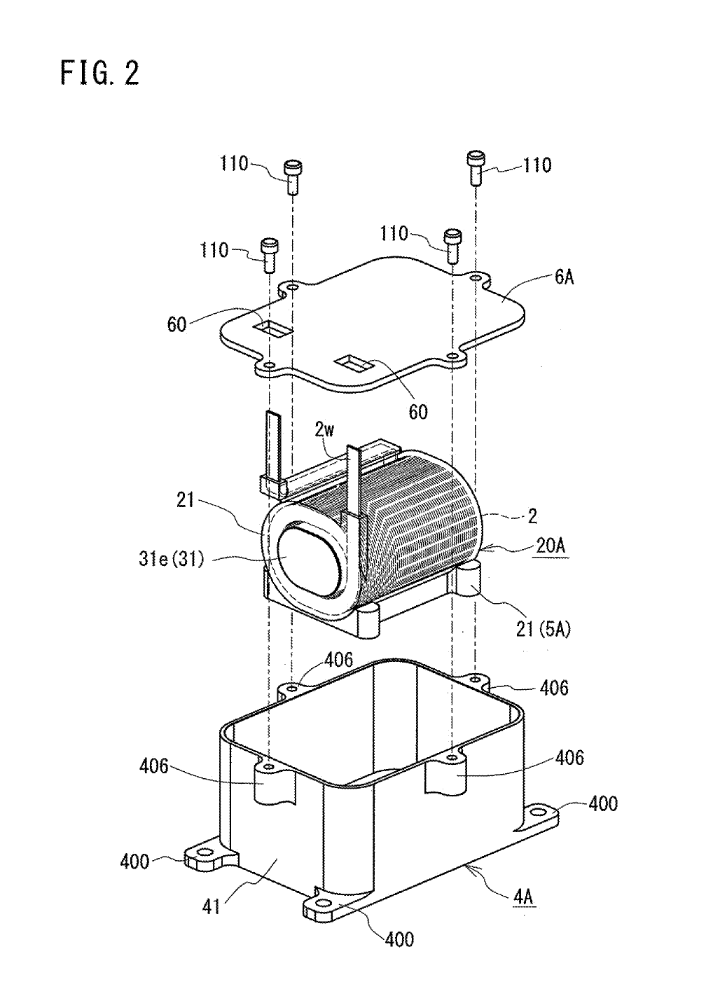

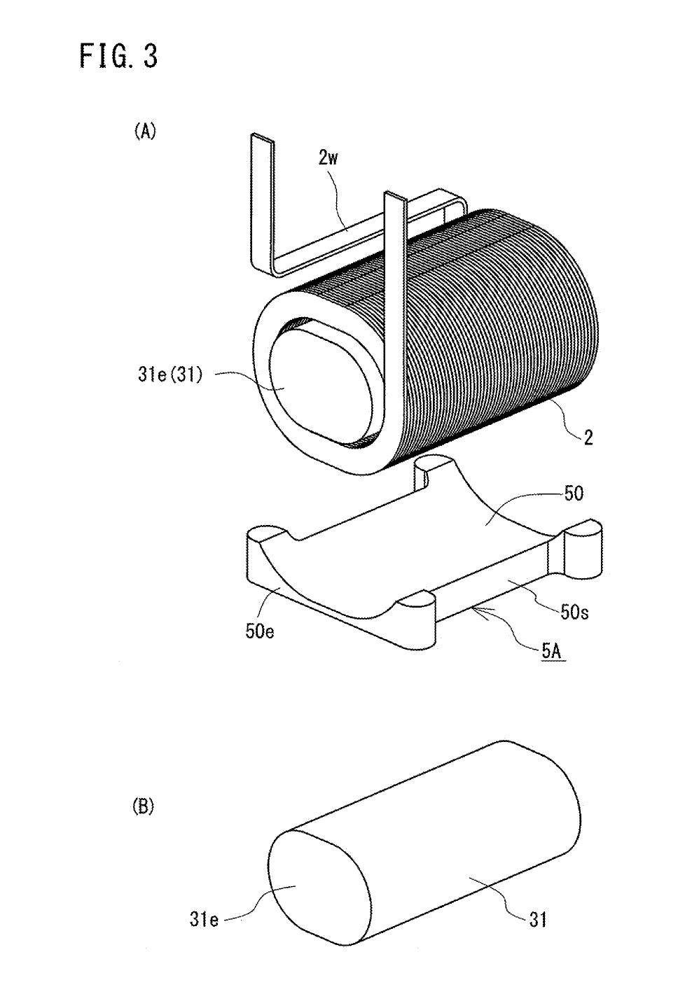

A description will be given of the coil component 20A with reference to FIGS. 2 and 3. The coil component 20A included in the reactor 1A according to the first embodiment includes the coil 2, the heat dissipating pedestal portion 5A, the inner core portion 31 structuring the magnetic core 3, and the resin mold portion 21 that integrally retains them.

### <Coil>

The coil 2 includes a coil element structured by a plurality of turns formed by one continuous wire 2w being spirally wound. The wire 2w is suitably a coated wire that includes a conductor made of a conductive material such as copper, aluminum, or alloy thereof. The conductor is provided with an insulating coat made of an insulating material (representatively, an enamel material such as polyamide-imide) around its outer circumference. The conductor may be of a variety of shape, such as a rectangular wire whose cross-sectional shape is rectangular, a round wire whose cross-sectional shape is circular, or a deformed wire whose cross-sectional shape is polygonal. Herein, the coil (coil element) 2 is an edgewise coil formed by a coated rectangular wire being wound edgewise, in which the conductor is a rectangular wire made of copper, and the insulating coat is made of enamel. The edgewise coil can increase the space factor to form a compact coil, and contributes toward reducing the size of the reactor.

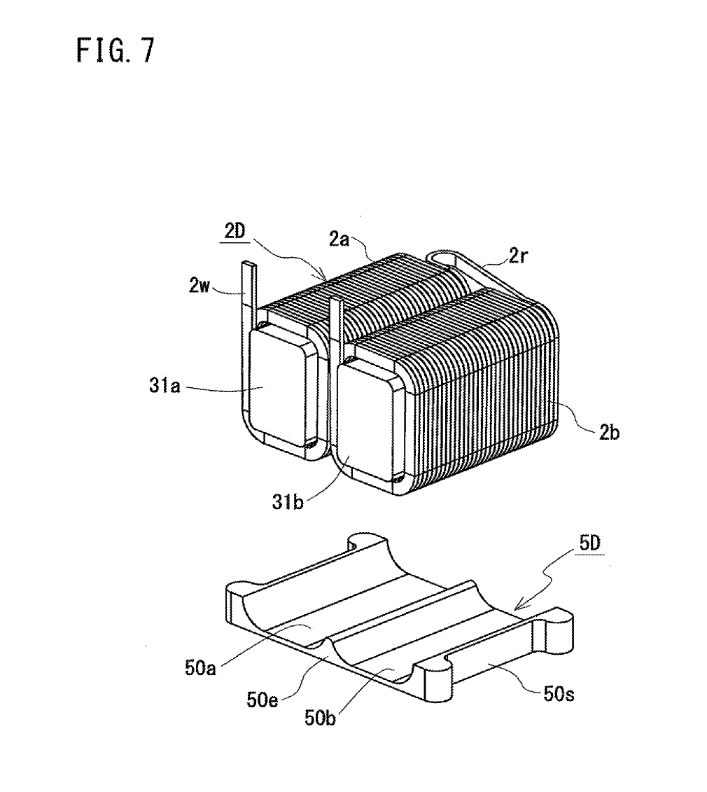

The end face shape of the coil (coil element) 2 can be selected as appropriate. Herein, the end face is in a racetrack shape formed by a combination of straight lines and arcs, and at least part of the outer circumferential face of the coil 2 is formed by a flat surface. Herein, the reactor 1A according to the first embodiment is in the horizontal storage mode in which the coil 2 is stored in the case 4A such that the axis of the coil 2 becomes parallel to an outer bottom face 40o (FIG. 1 (B)) formed by a flat surface in the case 4A. In the horizontal storage mode, since the flat surface of the outer circumferential face of the coil 2 is disposed in parallel to the outer bottom face 40o of the case 4, the coil 2 can be disposed in a stable manner, and the region in which the distance from the outer circumferential face of the coil 2 to the outer bottom face 40o is short can be increased. Thus, the heat dissipating characteristic can be enhanced. Accordingly, in the horizontal storage mode, the coil in which at least part of its outer circumferential face is formed by a flat surface, such as the aforementioned racetrack shape, is preferable. Other suitable shape may include, for example, a coil whose end faces are each a polygon (e.g., a rectangle) having corner portions rounded (see FIG. 7 whose description will follow). On the other hand, when the end face shape of the coil 2 is substantially solely made of a curve, such as a circle or an ellipse, the wire can easily be wound even when the wire is a rectangular wire, and hence excellent manufacturability of the coil is exhibited. Even with the cylindrical coil, the coil can be disposed in a stable manner thanks to provision of the heat dissipating pedestal portion 5A.

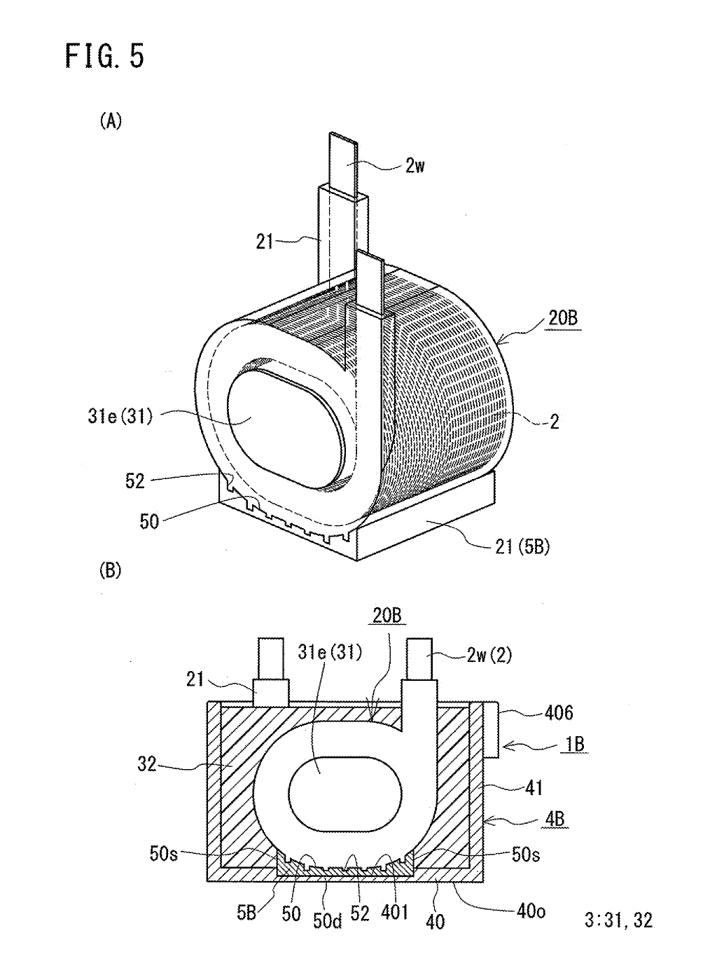

In connection with the wire 2w forming the coil 2, the region in each end portion side is drawn out as appropriate from the turn portion as shown in FIG. 3, and a terminal member (not shown) made of a conductive material such as copper or aluminum is connected thereto. Via the terminal member, the coil 2 is supplied with power. In the first embodiment, the region on one end portion side of the wire 2w is drawn out in the radial direction on one end side of the coil 2. The region on other end portion side of the wire 2w is folded back toward one end side of the coil 2, and similarly drawn out in the radial direction (in FIG. 3, the opposite end portions are both drawn out upward from the wire 2w). This makes it possible to dispose the opposite end portions of the wire 2w at one end side of the coil 2, and attaching work of the terminal members and the like can be carried out with ease. The draw-out direction of the opposite end portions of the wire 2w can be selected as appropriate. For example, the opposite end portions of the wire 2w can be drawn out respectively at one end side and other end side of the coil 2 as shown in a second embodiment, which will be described later (FIG. 5). Note that, though the opposite end portions of the wire 2w are representatively exposed outside the case 4A, they may be stored in the case 4A.

In the coil 2, in some cases, high voltages may be applied to the drawn out portions of the wire 2w extended from the turn portion, as compared to the turn portion. Accordingly, when an insulating substance is disposed at least at a portion in each drawn out portion of the wire 2w being brought into contact with the magnetic core 3 (the outer core portion 32) (FIG. 1), insulation between the coil 2 and the magnetic core 3 (in particular, the outer core portion 32) can be enhanced. Herein, as shown in FIGS. 1 and 2, the drawn out portions of the wire 2w are covered by the resin mold portion 21. In other mode, an insulating paper, an insulating tape (e.g., a polyimide tape), or an insulating film (e.g., polyimide film) may be wrapped around as appropriate; an insulating material may be dip-coated; or an insulating tubing (any of a heat shrink tubing and a cold shrink tubing) may be disposed. In the mode in which the drawn out portions of the wire 2w are not covered by the resin mold portion, since the outer shape of the resin mold portion can be simplified, the coil component can be molded with ease. In the mode in which the drawn out portions of the wire 2w are covered by the resin mold portion, it is not necessary to separately dispose an insulating substance, and a reduction in the number of steps can be achieved.

<Inner Core Portion>

As shown in FIG. 3 (B), the inner core portion 31 inserted and disposed inside the coil 2 is a columnar element having an outer shape that conforms to the inner circumferential shape of the coil 2. Herein, the inner core portion 31 is formed by a powder magnetic core in which soft magnetic metal powder is used. Details thereof will be given later.

<Heat Dissipating Pedestal Portion>

The heat dissipating pedestal portion 5A is disposed to cover part of the surface of the coil 2, and this disposition state is maintained by the resin mold portion 21 (FIG. 2). The heat dissipating pedestal portion 5A is, in the state where the reactor 1A has been assembled, fixed to the bottom portion 40 (FIG. 1) of the case 4A, and forms part of the case 4A and supports the coil 2. Furthermore, the heat dissipating pedestal portion 5A functions as a heat dissipation path.

Since the heat dissipating pedestal portion 5A is disposed in close proximity to the coil 2, the material thereof should be a non-magnetic material. Further, since the heat dissipating pedestal portion 5A is used as the heat dissipation path of the coil 2, the material thereof should be a metal material, which generally exhibits excellent thermal conductivity. The constituent material of the heat dissipating pedestal portion 5A may include, for example, aluminum, aluminum alloy, magnesium, and magnesium alloy. Since the non-magnetic metals noted herein are lightweight, they are suitable as a constituent material of an in-vehicle component which is desired to be lightweight. Since the heat dissipating pedestal portion 5A is made of metal, the heat dissipating pedestal portion in a desired shape can be easily manufactured by casting, cutting work, plastic work and the like. Herein, the heat dissipating pedestal portion 5A is made of aluminum alloy.

As shown in FIG. 3 (A), the heat dissipating pedestal portion 5A is a quadrangular plate-like member, and the length of the heat dissipating pedestal portion 5A in the axial direction of the coil 2 is substantially identical to the length of the coil 2 in the axial direction. The heat dissipating pedestal portion 5A is disposed along the outer circumferential face of the coil (coil element) 2 over the entire length of the coil 2. One face that opposes to the outer circumferential face of the coil 2, i.e., a supporting face 50, is in a shape that conforms to the outer circumferential face of the coil 2. The supporting face 50 is formed by curved surfaces and a flat surface, similarly to the outer circumferential face of the coil 2 in a racetrack shape. The supporting face 50 has an area capable of covering part of the outer circumferential face of the coil 2, herein the region on the installation side (on the bottom side in FIG. 3 (A)). A face being opposite to the supporting face 50, i.e., an installation face 50d (the bottom face in FIG. 1 (B)) is formed by a flat surface, and is in contact with the inner bottom face of the case 4A formed by a flat surface (FIG. 1 (B)). End faces 50e of the heat dissipating pedestal portion 5A are each ]-shaped, the thickness of which is small at the center portion and increases toward the opposite edge sides. Side faces 50s are each formed by a rectangular flat surface.

The corner portions of the heat dissipating pedestal portion 5A have fixing holes 51 with which bolts (fastening member) 100 are screwed for fixing the heat dissipating pedestal portion 5A to the case 4A (FIG. 1 (B)). As shown in FIG. 3 (A), formation portions of the fixing holes 51 project from the side faces 50s. So long as the heat dissipating pedestal portion 5A can be fixed or positioned to the case 4A, the number of the fixing holes 51 can be selected as appropriate. Employing the fixation structure achieved by the bolts 100, the position of the coil component 20A relative to the case 4A can be fully maintained.

The heat dissipating pedestal portion may not include the fixing holes. For example, employing the mode in which the installation face of the heat dissipating pedestal portion is disposed to be in contact with the case, the bolts can be dispensed with, and a reduction in the number of pieces of components and elimination of the fastening work can be achieved. Thus, excellent assemblability is exhibited. Alternatively, employing the mode in which the heat dissipating pedestal portion is fixed to the case by an adhesive agent, the following advantages can be obtained: (1) a reduction in the number of components; (2) an improvement in adhesion between the heat dissipating pedestal portion and the case; and (3) maintenance of the disposition state of the coil component relative to the case.

Alternatively, the heat dissipating pedestal portion and the case may each have an engaging portion. For example, as in a second embodiment whose description will be given later, a case 4B may be provided with a pedestal groove 401 (FIG. 5 (B)), whereas at least part of a heat dissipating pedestal portion 5B may be fitted into the pedestal groove 401; the case may be provided with a projection, whereas the heat dissipating pedestal portion may be provided with a through hole or a concave portion into which the projection is fitted; the case may be provided with a concave portion, whereas the heat dissipating pedestal portion may be provided with a projection fitted into the concave portion; or the foregoing modes may be practiced in combination. Further, the adhesive agent described above may be used in combination. In any of the foregoing modes, the coil component can be positioned relative to the case with ease, and the position of the coil component can be maintained. It is also possible that the case is provided with a positioning projection, and positioning is performed by causing part of the heat dissipating pedestal portion to be brought into contact with the projection.

Since substantially the entire outer circumference of the coil 2 is covered by the resin mold portion 21, whose description will follow, the resin forming the resin mold portion 21 is interposed between the coil 2 and the heat dissipating pedestal portion 5A. Accordingly, insulation between the coil 2 and the heat dissipating pedestal portion 5A mainly made of a metal material can be enhanced. Herein, since the supporting face 50 of the heat dissipating pedestal portion 5A conforms to the outer circumferential face of the coil 2, the resin forming the resin mold portion 21 is present by a uniform thickness between the coil 2 and the supporting face 50 (FIG. 1 (B)).

When at least part of the surface of the heat dissipating pedestal portion 5A, particularly the region covered by the resin mold portion 21 whose description will follow, is subjected to surface roughening treatment, adhesion between the heat dissipating pedestal portion 5A and the resin forming the resin mold portion 21 can be enhanced and hence it is preferable. In particular, in order to enhance adhesion between the coil 2 and the heat dissipating pedestal portion 5A, at least part of the supporting face 50 covering the outer circumferential face of the coil 2 in the heat dissipating pedestal portion 5A is preferably subjected to the surface roughening treatment.

The surface roughening treatment may include, for example, a process of providing minor concave and convex whose maximum height is 1 mm or less, preferably 0.5 mm or less. Specifically, known schemes for enhancing adhesion between metal and resin can be employed, such as: (1) anodic oxidation treatment represented by aluminum anodizing; (2) acicular plating by any known scheme; (3) implanting a molecular junction compound by any known scheme; (4) fine groove work by laser; (5) nano-order dimple formation using any known special solution; (6) etching process; (7) sand blasting or shot blasting; (8) filing; (9) delustering treatment by sodium hydroxide; and (10) abrasion by a wire brush. An increase in the surface area by such surface roughening is expected to improve the heat dissipating characteristic also.

Further, an increase in the surface area of the heat dissipating pedestal portion 5A may be achieved also by forming any groove (the second embodiment whose description will follow) or hole by subjecting a general metal to cutting work, or by shaping the surface into a concave-convex shape by casting, plastic work and the like. Thus, an improvement in adhesion or the heat dissipating characteristic attributed to an increase in the contact area between the heat dissipating pedestal portion 5A and the resin forming the resin mold portion 21 can be expected.

In the heat dissipating pedestal portion 5A, as the region covered by the resin mold portion 21 is greater, adhesion between the heat dissipating pedestal portion 5A and the resin mold portion 21 can be enhanced. As a result, the coil 2 as well as the heat dissipating pedestal portion 5A are strongly retained by the resin mold portion 21. Herein, the heat dissipating pedestal portion 5A is covered by the resin mold portion 21 except for the installation face 50d, which is the contact face relative to the case 4A. Since the installation face 50d is exposed outside the resin mold portion 21, heat is easily transferred from the heat dissipating pedestal portion 5A to the case 4A, and an excellent heat dissipating characteristic is obtained. In other possible mode, part of or each of the end faces 50e and side faces 50s may be exposed outside the resin mold portion 21.

<Resin Mold Portion>

The resin mold portion 21 covers at least part of the surface of the coil 2 and retains the coil 2 in a certain shape. The coil 2 is not expanded or compressed thanks to the resin mold portion 21, and hence can be handled with ease during assembly. Further, herein, the resin mold portion 21 also functions to retain the coil 2 in a compressed state than its natural length. Accordingly, the length of the coil 2 is shorter than its natural length, and the coil 2 is small in size. Further, since the resin mold portion 21 is made of an insulating resin and covers the surface of the coil 2, it also functions to enhance insulation between the coil 2 and surrounding members (the magnetic core 3, the heat dissipating pedestal portion 5A and the like). Further, the resin mold portion 21 also functions as a member that integrally retains the coil 2 and the heat dissipating pedestal portion 5A. In connection with the reactor 1A according to the first embodiment, the resin mold portion 21 further integrally retains the coil 2, the heat dissipating pedestal portion 5A, and the inner core portion 31. Accordingly, since the reactor 1A employs such a coil component 20A, the number of assembled components is small and excellent assemblability is exhibited.

Herein, the resin mold portion 21 covers the assembled product made up of the coil 2, the inner core portion 31 inserted and disposed inside the coil 2, and the heat dissipating pedestal portion 5A disposed to cover part of the outer circumferential face of the coil 2, except for the opposite end portions of the wire 2w to which the terminal members are connected and the installation face 50d of the heat dissipating pedestal portion 5A. That is, the inner circumferential face and outer circumferential face, a pair of end faces, and part of the drawn out portions of the wire 2w of the coil 2; the entire outer circumferential face of the inner core portion 31; and the supporting face 50, side faces 50s and end faces 50e of the heat dissipating pedestal portion 5A, are covered by the resin mold portion 21.

The area covered by the resin mold portion 21 can be selected as appropriate. For example, part of the turn portion of the coil 2 may not be covered by the resin mold portion 21 and may be exposed outside. Specifically, even when the resin forming the resin mold portion 21 is interposed only between the coil 2 and the heat dissipating pedestal portion 5A, maintenance of the shape of the coil 2 and insulation between the coil 2 and the heat dissipating pedestal portion 5A can be achieved. Alternatively, of the outer circumference of the coil 2, when at least the portion covered by the composite material forming the outer core portion 32 is covered by the resin forming the resin mold portion 21, maintenance of the shape of the coil 2 and insulation between the coil 2 and the magnetic core 3 (the outer core portion 32) can be achieved. However, as in the present embodiment, when the coil 2 is substantially entirely covered, the resin forming the resin mold portion 21 is interposed between the coil 2 and the magnetic core 3, and between the coil 2 and the heat dissipating pedestal portion 5A. Therefore, insulation between the coil 2 and the magnetic core 3 and between the coil 2 and the heat dissipating pedestal portion 5A can be enhanced. Further, as the region of the coil 2 covered by the resin mold portion 21 is greater, the shape of the coil 2 can be retained easier.

Herein, though the opposite end faces 31e of the inner core portion 31 and the nearby area of the opposite end faces 31e are not covered by the resin mold portion 21 and exposed outside, to be brought into contact with the composite material forming the outer core portion 32 whose description will follow, it is possible to employ the mode in which at least one end face 31e is covered by the resin mold portion 21. At this time, the resin on the end face 31e of the inner core portion 31 can be used as a gap.

The thickness of the resin mold portion 21 can be selected as appropriate, e.g., about 0.1 mm to 10 mm. As the thickness of the resin mold portion 21 is greater, the insulation performance can be enhanced; as the thickness is smaller, the heat dissipating characteristic can be enhanced, and moreover, a reduction in size of the coil component can be achieved. When the small thickness is employed, the thickness is preferably about 0.1 mm to 3 mm, and should be selected as appropriate within a range satisfying desired insulating strength and the like. Further, the thickness may be uniform over the entire covered portion, or may be partially varied. For example, as shown in FIG. 1 (B), when the thickness of the portion in the resin mold portion 21 covering only the heat dissipating pedestal portion 5A is relatively small, while the thickness of the portion covering the coil 2 is relatively great, insulation between the coil 2 and the magnetic core 3 and insulation between the coil 2 and the heat dissipating pedestal portion 5A can be effectively enhanced. Herein, the thickness of the portion in the resin mold portion 21 covering the surface of the coil 2 is set to be uniform, and the thickness of the portion covering only the heat dissipating pedestal portion 5A is also set to be uniform though the thickness is small. Accordingly, the outer shape of the coil component 20A is in a similar shape as the assembled product made up of the coil 2, the inner core portion 31, and the heat dissipating pedestal portion 5A. Note that, the coil 2 and the inner core portion 31 are coaxially disposed by the resin forming the resin mold portion 21 interposed between the coil 2 and the inner core portion 31.

As the insulating resin that forms the resin mold portion 21, what is preferably used is any resin that has the insulating characteristic with which the coil 2 and the magnetic core 3, and the coil 2 and the heat dissipating pedestal portion 5A can be fully insulated from each other, and the heat resistance with which the resin does not soften when the maximum temperature is reached during operation of the reactor 1A. Further, the resin should be capable of being subjected to transfer molding or injection molding. For example, thermosetting resin such as epoxy resin, silicone resin, and unsaturated polyester, or thermoplastic resin such as polyphenylene sulfide (PPS) resin and liquid crystal polymer (LCP) can be suitably used. When a mixture of the resin and a filler made of at least one type of ceramic selected from silicon nitride, alumina, aluminum nitride, boron nitride, and silicon carbide is used for the resin mold portion 21, insulation performance can be improved, and the heat dissipating characteristic can also be improved. In particular, when the resin whose thermal conductivity is 1 W/m·K or more, furthermore 2 W/m·K or more, is used for the resin mold portion 21, an excellent heat dissipating characteristic can be obtained and hence is preferable. Herein, for the resin mold portion 21, epoxy resin (thermal conductivity: 2 W/m·K) containing a filler is used.

In manufacturing the coil component 20A, for example, a manufacturing method disclosed in Japanese Unexamined Patent Publication No. 2009-218293 can be used. The coil component 20A can be manufactured by various molding methods such as injection molding, transfer molding, cast molding and the like. More specifically, by storing the coil 2, the inner core portion 31, and the heat dissipating pedestal portion 5A in a mold assembly, and disposing any appropriate support member such that the foregoing elements are covered by resin by a desired thickness. Thus, the resin mold portion 21 can be molded and the coil component 20A can be manufactured.

In manufacturing the coil component 20A, disposing an interval retaining member (not shown) for retaining the interval between the coil 2 and the inner core portion 31, it becomes easier to simplify the structure of the mold assembly. The interval retaining member may be, for example: a sleeve-like member (may be short, and such a sleeve-like shape may be formed by a combination of a plurality of divided pieces) disposed at the outer circumference of the inner core portion 31; an annular member having an L-shaped cross section and including the aforementioned sleeve-like member and one or more flat plate-like flange portions projecting outward from the periphery of the sleeve-like member; a plate member disposed between the coil 2 and the inner core portion 31; and a combination of the foregoing. Since the interval retaining member is integrated with the coil 2 and others by the resin forming the resin mold portion 21, when it is made of an insulating resin such as PPS resin, LCP, polytetrafluoroethylene (PTFE) resin described above, insulation between the coil 2 and the inner core portion 31 can be enhanced. When the sleeve-like member or the annular member described above is employed, the shape or thickness thereof is adjusted by partially reducing the thickness or providing cutting, such that the resin forming the resin mold portion 21 is fully packed between the coil 2 and the inner core portion 31.

(Magnetic Core)

As described above, the magnetic core 3 includes the columnar inner core portion 31 (FIG. 3 (B)) and the outer core portion 32 (FIG. 1) disposed at at least one of the end faces 31e of the inner core portion 31 (herein the opposite end faces) and on the outer circumferential side of the coil 2. The outer core portion 32 substantially covers the outer circumferential face of the coil component 20A. The magnetic core 3 forms a closed magnetic path when the coil 2 is energized.

<Inner Core Portion>

Herein, since the inner core portion 31 is slightly longer than the length of the coil 2 in the axial direction, the opposite end faces 31e and nearby outer circumferential face of the inner core portion 31 are slightly project from the end faces of the coil 2 in the state where the inner core portion 31 is inserted and disposed in the coil 2 (FIG. 2). This state is maintained by the resin mold portion 21. The length of the inner core portion 31 projecting from each end face of the coil 2 (hereinafter referred to as the projection length) can be selected as appropriate. Herein, though each projection length is equal, it may be different. Alternatively, the length of the inner core portion or the disposition position of the inner core portion relative to the coil can be adjusted such that the projecting portion is present at only one of the end faces of the coil 2. When the length of the inner core portion is equal to or greater than the length of the coil, the magnetic flux formed by the coil 2 can be allowed to fully pass through the inner core portion 31.

Though the magnetic core 3 may be made of a uniform material in its entirety, herein, the material of the magnetic core 3 is partially different. The inner core portion 31 is formed by a powder magnetic core, whereas the outer core portion 32 is formed by a composite material.

The powder magnetic core is representatively manufactured by molding raw material powder under pressure, and thereafter performing thermal treatment as appropriate. Even when the powder magnetic core is in a complicated three-dimensional shape, it can be molded relatively easily. The raw material powder may include coated powder in which the surface of metal particles made of an iron base material (iron group metal or iron alloy) or a soft magnetic material such as rare-earth metal is provided with an insulating coat made of silicone resin or phosphate, ferrite powder, or mixed powder in which resin such as thermoplastic resin or an additive such as higher fatty acid (representatively, the additive that vanishes or changes into an insulating substance by thermal treatment) is mixed as appropriate. By the foregoing manufacturing method, a powder magnetic core in which an insulating substance is interposed among the soft magnetic particles can be obtained. Since the powder magnetic core exhibits excellent insulation performance, the eddy current loss can be reduced. Further, the powder magnetic core can increase the saturation magnetic flux density than the composite material forming the outer core portion 32 does, when the raw material or the manufacturing condition is adjusted by the soft magnetic powder of the raw material or the molding pressure being increased. As the powder magnetic core, a known powder magnetic core can be employed.

The columnar inner core portion 31 may be an integrated element that is molded using a mold assembly of a desired shape, or a lamination product in which a plurality of core pieces each made of the powder magnetic core are laminated. The lamination products can be fixed by an adhesive agent or an adhesive tape to be an integrated element. Herein, the inner core portion 31 is a solid element in which no gap member or air gap is interposed.

<Outer Core Portion>

Herein, the outer core portion 32 is in a shape conforming to the space formed by the inner circumferential face of the case 4A and the outer circumferential face of the coil component 20A stored in the case 4A. The coil component 20A is covered by the outer core portion 32 except for the installation face 50d being brought into contact with the case 4A and the opposite end portions of the wire 2w. Since part of the outer core portion 32 is provided so as to be coupled to the opposite end faces 31e of the inner core portion 31, the magnetic core 3 forms a closed magnetic path.

The composite material forming the outer core portion 32 can be representatively manufactured by injection molding, transfer molding, MIM (Metal Injection Molding), cast molding, press molding using magnetic substance powder and powdery solid resin, and the like. In the injection molding, a prescribed pressure is applied to a mixture containing magnetic substance powder and resin while the mixture is packed into a mold assembly, and thus the mixture is molded. Thereafter, the resin is cured, whereby the composite material is obtained. In the transfer molding and the MIM also, molding is performed by packing a raw material into a mold assembly. In the cast molding, the mixture is poured into a mold assembly or the case 4A without application of a pressure. Then, the mixture is molded and cured, whereby the composite material is obtained.

When a mold assembly is used to separately form the composite material, the time required for packing the raw material is short. Therefore, the composite material can be produced in a large quantity, and hence excellent productivity is exhibited. In this mode, a mold product being the composite material released from the mold assembly is assembled to the coil component 20A and stored in the case 4A. Then, by fixing the heat dissipating pedestal portion 5A to the case 4A, the reactor 1A is obtained. Further, in this mode, the composite materials, or the inner core portion 31 and the outer core portion 32 can be joined to each other by an adhesive agent. Further, in this mode, an adhesive agent or a sealing resin (which will be described later) may be packed between the outer core portion 32 and the wall portion 41 of the case 4A, so as to improve adhesion between them. In this mode, for example, producing a plurality of composite materials each having a ]-shaped cross section and combining them, the coil component 20A can be easily covered. When the inner face shape of the composite materials with a ]-shaped cross section is in a shape conforming to the outer shape of the coil component 20A, the magnetic path can be fully secured. When the inner face shape of the composite material does not exactly conform to the shape of the coil component 20A, but it is in a simple shape roughly conforming to the shape (e.g., the inner space formed by a combination of a plurality of composite materials is in a rectangular parallelepiped-shape), excellent moldability of the composite material is achieved.

On the other hand, when the raw material is directly packed into the case 4A using the case 4A as a mold assembly to form the composite material, the following advantages are obtained: (1) the aforementioned molding step, assembling step, and joining step of the magnetic core 3 can be omitted; (2) the outer core portion 32 having a shape conforming to the coil component 20A can be easily molded even when the coil component 20A has a complicated shape; (3) the case 4A and the composite material can be easily closely brought into contact with each other. Particularly, when the inner face of the case 4A is also subjected to the surface roughening treatment similarly to the heat dissipating pedestal portion 5A, the contact area between the case 4A and the outer core portion 32 can be increased, whereby the heat dissipating characteristic can be enhanced; and (4) the position of the stored item in the case 4A will not easily shift during the packing procedure of the raw material.

The magnetic substance powder in the composite material forming the outer core portion 32 may be of the same composition as the soft magnetic powder forming the inner core portion 31 described above, or may be of different composition. In the situation where they are identical in composition also, since the composite material contains resin being a non-magnetic material, it is lower in saturation magnetic flux density and in relative permeability than the powder magnetic core. Accordingly, forming the outer core portion 32 by the composite material, it becomes possible to set the outer core portion 32 to be lower in relative permeability than the inner core portion 31 made of the powder magnetic core. Further, since the inner core portion 31 is the powder magnetic core, the saturation magnetic flux density can be increased easily as compared to the composite material disposed around the outer circumference of the coil 2.

The magnetic substance powder in the composite material may be made of a single type of powder or a plurality of types of powder differing in material. The composite material forming the outer core portion 32 is preferably iron base powder such as pure iron powder. Further, when the composite material is coated powder similarly to the powder magnetic core, insulation among soft magnetic particles can be enhanced, whereby the eddy current loss can be reduced.

The average particle size of the magnetic substance powder in the composite material may be 1 μm or greater and 1000 μm or less, particularly 10 μm or more and 500 μm or less. Further, when the magnetic substance powder includes a plurality of types of powder differing in particle size (coarse powder and fine powder), a reactor with high saturation magnetic flux density and low loss can be easily obtained. Note that, the magnetic substance powder in the composite material is substantially identical to the powder of the raw material (maintained). Using the powder whose average particle size falls within the range noted above as the raw material, excellent flowability is exhibited. Thus, by injection molding or the like, a composite material can be manufactured highly productively.

The content of the magnetic substance powder in the composite material forming the outer core portion 32 may be 40 volume percent or more and 70 volume percent or less, when the composite material is 100 percent. Since the magnetic substance powder is 40 volume percent or more, the proportion of the magnetic component is fully high, whereby the magnetic characteristic such as the saturation magnetic flux density of the whole magnetic core 3 can be enhanced easier. When the magnetic substance powder is 70 volume percent or less, excellent manufacturability of the composite material is achieved.

The resin serving as the binder in the composite material may be representatively thermosetting resin such as epoxy resin, phenolic resin, silicone resin, and urethane resin. Other example may include thermoplastic resin such as PPS resin, polyimide resin, fluororesin, and polyamide resin, room temperature curing resin, and low temperature curing resin.

It is also possible to employ a composite material containing, in addition to the magnetic substance powder and the resin, powder (filler) made of a non-magnetic substance such as ceramic, e.g., alumina or silica. The filler contributes toward improving the heat dissipating characteristic, and suppressing uneven distribution of the magnetic substance powder (uniform dispersion). Further, when the filler is in a form of fine particles, since the filler is interposed among the magnetic substance particles, a reduction in the proportion of the magnetic substance powder attributed to the contained filler can be suppressed. When the composite material is 100 mass percent, the content of the filler should be 0.2 mass percent or more and 20 mass percent or less, furthermore 0.3 mass percent or more and 15 mass percent or less, particularly 0.5 mass percent or more and 10 mass percent or less. Thus, the effects described above can be fully obtained.

Herein, the outer core portion 32 is formed by the composite material made up of coated powder, in which particles of iron base material (pure iron) whose average particle size is 75 μm or less are provided with an insulating coat on their surface, and epoxy resin (the content of pure iron powder in the composite material is 40 volume percent). Further, no gap member or air gap is interposed in the outer core portion 32 also. Accordingly, the magnetic core 3 is entirely free of gap. Since no gap is included, the following advantages are obtained: (1) a reduction in size; (2) a reduction in loss; and (3) suppression of a reduction in inductance when being energized with great current. Note that, in the magnetic core 3, gap members made of a non-magnetic material, e.g., alumina plates, or air gaps may be interposed.

The shape of the outer core portion 32 is not particularly limited so long as a closed magnetic path can be formed. As in the present embodiment, when substantially the entire circumference of the coil component 20A is covered by a composite material, the composite material (the outer core portion 32) can strengthen the protection of the coil component 20A from the external environment or mechanical protection thereof. Further, since not only the coil 2 but also the outer core portion 32 can be brought into contact with the heat dissipating pedestal portion 5A (FIG. 1 (B)), the heat from the outer core portion 32 also can be transferred to the outside of the case 4A via the heat dissipating pedestal portion 5A.

The coil component 20A may be partially exposed outside the composite material. For example, when a region in the outer circumferential face of the coil 2 (coil component 20A) disposed on the opening side of the case 4A is exposed, it is expected that the heat dissipating characteristic can be enhanced.

<Magnetic Characteristic>

As described above, since the magnetic core 3 is made of different materials, the magnetic core 3 is partially different in the magnetic characteristic. Herein, the inner core portion 31 is higher in saturation magnetic flux density than the outer core portion 32, and the outer core portion 32 is lower in relative permeability than the inner core portion 31. Specifically, the inner core portion 31 made of the powder magnetic core has a saturation magnetic flux density of 1.6 T or more, and that is 1.2 times or more as great as the saturation magnetic flux density of the outer core portion 32. The relative permeability of the inner core portion 31 is 100 or more and 500 or less. The outer core portion 32 made of the composite material has a saturation magnetic flux density of 0.6 T or more, and that is less than the saturation magnetic flux density of the inner core portion 31. The relative permeability of the outer core portion 32 is 5 or more and 50 or less, preferably 10 or more and 30 or less. The relative permeability of the entire magnetic core 3 made up of the inner core portion 31 and the outer core portion 32 is 10 or more and 100 or less. In the mode in which the saturation magnetic flux density of the inner core portion is high, when it is intended to obtain the magnetic flux identical to that of the magnetic core as a whole having uniform saturation magnetic flux density, the cross-sectional area of the inner core portion can be reduced. Therefore, this mode contributes toward reducing the size of the reactor. In this mode, the saturation magnetic flux density of the inner core portion 31 is 1.8 T or more, and further preferably 2 T or more. It is preferable that the saturation magnetic flux density of the inner core portion 31 is 1.5 times, more preferably 1.8 or more, as great as the saturation magnetic flux density of the outer core portion 32. Using a lamination product of electromagnetic steel sheets represented by silicon steel plates in place of the powder magnetic core, the saturation magnetic flux density of the inner core portion can be increased further easier. On the other hand, when the relative permeability of the outer core portion 32 is set to be lower than that of the inner core portion 31, the magnetic saturation can be suppressed. Accordingly, for example, the magnetic core 3 of a gapless structure can be obtained. With the magnetic core 3 of a gapless structure, a leakage flux can be reduced.

(Case)

Herein, the case 4A storing the assembled product of the coil component 20A and the outer core portion 32 (magnetic core 3) is a container in which the plate-like bottom portion 40 (FIG. 1 (B)) and the frame-like wall portion 41 provided to stand from the bottom portion 40 are integrally molded, and the side opposite to the bottom portion 40 is opened. The outer bottom face 40o of the bottom portion 40 is formed by a flat surface, and when the reactor 1A is installed on the installation target such as a cooling base, at least part of (herein, the entire) the outer bottom face 40o becomes a cooled face that is cooled by being brought into contact with the installation target. Note that, the outer bottom face 40o is allowed to partially include a region (a flat surface or a curved surface) that is not brought into contact with the installation target. Further, though FIG. 1 shows the mode in which the outer bottom face 40o is disposed on the bottom side, it may be disposed on the side (right or left in FIG. 1) or on the top side.

Herein, the case 4A is provided with, at the bottom portion 40, bolt holes into which the bolts 100 are inserted. By the bolts 100 being screwed with the fixing holes 51 of the coil component 20A disposed at the bottom portion 40 and these bolt holes, the coil component 20A is fixed to the case 4A, and the heat dissipating pedestal portion 5A is integrated with the bottom portion 40.

Herein, in connection with the shape of the case 4A, though the bottom portion 40 is formed by a quadrangular plate, and the wall portion 41 is rectangular frame-shaped, such geometry can be selected as appropriate in accordance with the shape of the stored item and the like. The size of the case 4A can also be selected as appropriate in accordance with the stored item in the case 4A. Further, though the front and back faces of the bottom portion 40 (the inner bottom face and the outer bottom face 40o) are formed as flat surfaces, they may each have a concave-convex shape by being provided with engaging portions and the like, as described above.

The case 4A protects the stored item from the external environment (dust or corrosion) and provides mechanical protection. Further, in order for the case 4A to be used as a heat dissipation path, the constituent material of the case 4A is preferably a material being excellent in thermal conductivity, particularly, a material being higher in thermal conductivity than the magnetic substance powder forming the magnetic core 3. Further, when the case is made of a material being non-magnetic but conductive, a leakage flux toward the outside of the case can be prevented. Accordingly, as the material forming the case 4A, a non-magnetic metal material (the aforementioned aluminum or the like) similarly to the heat dissipating pedestal portion 5A can be used. The material forming the case 4A and that of the heat dissipating pedestal portion 5A may be the same or may be different. Herein, the case 4A is made of aluminum alloy.

In the situation where the composite material forming the outer core portion 32 is molded by cast molding using the case 4A as a mold assembly, employing the mode in which minor concave and convex are provided to at least part of the inner face of the case 4A, by preferably 50 area percent or more, further preferably 80 area percent or more, adhesion between the composite material and the case 4A can be enhanced, and the heat dissipating characteristic can be improved. In forming the minor concave and convex, the surface roughening treatment described above can be employed.

In addition, the case 4A includes attaching portions 400 for fixing the reactor 1A to the installation target. The attaching portions 400 are projecting pieces that project from the periphery of the bottom portion 40 toward the outside of the wall portion 41. The projecting pieces are each provided with a bolt hole into which a fastening member (not shown) such as a bolt is inserted. Herein, in the quadrangular case 4A, the corner portions are respectively provided with the attaching portions 400. Since the attaching portions 400 are provided, the reactor 1A can be fixed to the installation target with ease. The attaching position, number of pieces, shape and the like of the attaching portions 400 can be selected as appropriate. The attaching portions 400 can be dispensed with.

Further, a lid portion 6A shown in FIG. 2 is disposed so as to cover the opening portion of the case 4A. Since the lid portion 6A is provided, it becomes possible to prevent the stored item in the case 4A from coming off and to protect the stored item. Furthermore, when the lid portion 6A is made of a material being non-magnetic but conductive similarly to the constituent material of the case 4A, an occurrence of a leakage flux can be prevented. Further, when the lid portion 6A is made of a material with excellent thermal conductivity such as a metal material similarly to the case 4A, an improvement in the heat dissipating characteristic can also be expected.

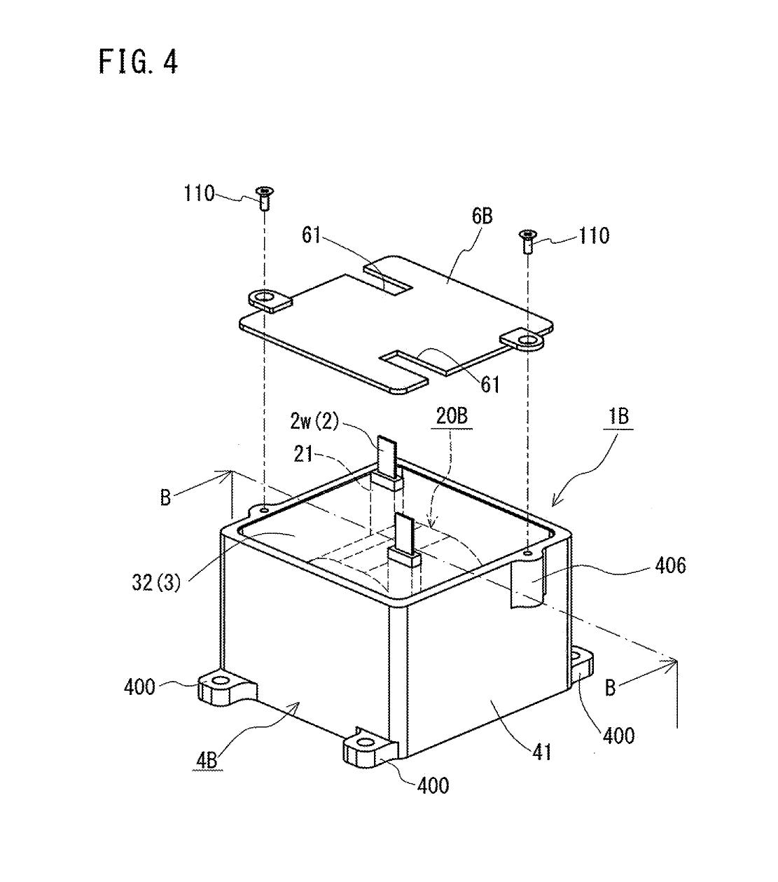

Herein, the lid portion 6A is a quadrangular plate member corresponding to the shape of the opening portion of the case 4A, and is provided with wire holes 60 into which end portions of the wire 2w are respectively inserted. Further, herein, the case 4A integrally includes, at its wall portion 41, lid pedestals 406 with which bolts 110 fixing the lid portion 6A are screwed. The lid portion 6A includes projecting pieces provided with bolt holes into which the bolts 110 are inserted. Herein, the lid pedestal 406 is provided at each of four faces forming the wall portion 41, and the projecting pieces of the lid portion 6A are provided at the position corresponding to the position of the lid pedestals 406 when the lid portion 6A is disposed on the case 4A. The formation places or number of pieces of the lid pedestals 406 and the projecting pieces can be selected as appropriate (FIG. 4 shows an example in which two lid pedestals 406 are provided).

(Uses)

The reactor 1A structured as described above can be suitably used where the energizing conditions are, for example: the maximum current (direct current) is about 100 A to 1000 A; the average voltage is about 100 V to 1000 V; and the working frequency is about 5 kHz to 100 kHz. Representatively, the reactor 1A can be suitably used as a constituent component of an in-vehicle power converter apparatus of an electric vehicle, a hybrid vehicle and the like.

(Size of Reactor)

When used as an in-vehicle component, the reactor 1A preferably has a capacity of about 0.2 liters (200 cm³) to 0.8 liters (800 cm³), including the case 4A. In the present embodiment, the capacity is about 540 cm³.

(Method of Manufacturing Reactor)

The reactor 1A can be manufactured as follows, for example. Herein, firstly, the coil 2, the inner core portion 31, and the heat dissipating pedestal portion 5 shown in FIG. 3 are separately prepared, which are then integrally molded by the resin mold portion 21 (FIG. 2), to obtain the coil component 20A (FIG. 2).

Next, when the outer core portion 32 is manufactured by cast molding using the case 4A as a mold assembly, as shown in FIG. 2, the coil component 20A is stored in the case 4A. Then, the heat dissipating pedestal portion 5A is fixed to the case 4A by the bolts 100 (FIG. 1 (B)). An adhesive agent or grease may be applied to the installation face 50d of the heat dissipating pedestal portion 5A or the inner bottom face of the case 4A as appropriate (the same holds true to the situation where the composite material is separately fabricated, whose description will follow, and to the embodiments described later). When grease or the like is interposed between the heat dissipating pedestal portion 5A and the case 4A, air is hardly interposed between them and they can be closely in contact with each other, whereby the heat dissipating characteristic can be enhanced. Then, a mixture is fabricated from the magnetic substance powder and resin being the raw material of the outer core portion 32, and binder or non-magnetic substance powder as appropriate. The mixture is packed into the case 4A serving as a mold assembly, and thereafter the resin is cured. At this time, since the coil component 20A is fixed to the case 4A by the bolts 100, the coil component 20A does not shift in the case 4A until the resin cures. Thus, the outer core portion 32 can be precisely molded. From the foregoing procedure, a reactor with no lid portion 6A can be obtained. Note that, the outer core portion 32 is not shown in FIG. 2.

On the other hand, when the outer core portion 32 is to be a mold product made of the composite material separately produced, a composite material (mold product) of a prescribed shape is prepared to assemble the composite material to the outer circumference of the coil component 20A. The mold product made of the composite material is molded such that the installation face 50d of the heat dissipating pedestal portion 5A included in the coil component 20A is exposed outside. Then, the obtained combined product is stored in the case 4A, and the heat dissipating pedestal portion 5A is fixed to the case 4A by the bolts 100 (FIG. 1 (B)). From the foregoing procedure, a reactor with no lid portion 6A can be obtained. Further, when the case 4A is not used as a mold assembly, but a mold product made of the composite material is used, the case 4A may be packed with a sealing resin. By the sealing resin, mold products each made of the composite material can be fixed to each other, or the mold product and the coil component can be fixed to each other. The sealing resin may be an insulating resin such as epoxy resin, urethane resin, silicone resin and the like. When the resin containing a filler with excellent insulation performance or heat dissipating characteristic is used as the sealing resin, insulation between the coil or the magnetic core and the case as well as the heat dissipating characteristic can be improved. Depending on the material of the sealing resin or the thickness thereof, vibrations or noises can be advantageously prevented.

Next, the lid portion 6A is disposed at the opening portion of the case 4A and bolts 110 are fastened, whereby the reactor 1A (FIG. 1) can be obtained.

(Effects)

In connection with the reactor 1A, since the coil 2 and the heat dissipating pedestal portion 5A are integrally retained by the resin mold portion 21 and the heat dissipating pedestal portion 5A forms part of the bottom portion of the case 4A, the coil 2 can be disposed in the case 4A in a stable manner. In particular, even in the horizontal storage mode as the reactor 1A, the coil 2 can be disposed in a stable manner. Then, via the heat dissipating pedestal portion 5A, the heat of the coil 2 can be efficiently transferred to the installation target. Accordingly, in connection with the reactor 1A, part of the magnetic core 3 (herein the outer core portion 32) is made of the composite material containing the magnetic substance powder and the resin. Despite the coil 2 being covered by this composite material, an excellent heat dissipating characteristic is obtained.

In particular, since the reactor 1A according to the first embodiment is in the horizontal disposition mode as described above, there are many regions in which the distance from the outer circumferential face of the coil 2 to the installation target is short. Further, in connection with the reactor 1A, since the heat dissipating pedestal portion 5A has the supporting face 50 conforming to the outer circumferential face of the coil 2, the heat of the coil 2 can be transferred to the heat dissipating pedestal portion 5A easier. Further, with the reactor 1A, since the heat dissipating pedestal portion 5A is strongly fixed to the case 4A by fastening members such as the bolts 100, the heat of the coil 2 is transferred to the installation target easily via the heat dissipating pedestal portion 5A. Thanks to these points also, the reactor 1A has an excellent heat dissipating characteristic.

Further, since the heat dissipating pedestal portion 5A is made of a non-magnetic material, it magnetically influences the coil 2 very little even when the heat dissipating pedestal portion 5A is disposed in close proximity to the coil 2. Further, since the heat dissipating pedestal portion 5A is included, the shape of the case 4A can be simplified, whereby the case 4A can be molded with ease. In addition, the resin mold portion 21 made of an insulating resin secures insulation between the coil 2 and the heat dissipating pedestal portion 5A which are mainly made of metal. Further, since the reactor 1A includes the coil component 20A as a constituent element, the coil 2 can be handled with ease. Furthermore, the number of assembled components is small, and hence excellent assemblability is exhibited. In particular, with the reactor 1A, since the coil component 20A integrally retains part of the magnetic core 3 (the inner core portion 31) also, further excellent assemblability is exhibited.

In addition, since at least part of the magnetic core 3 (herein the outer core portion 32) is the composite material described above, the following effects are attained.

(1) The outer core portion 32 can be formed with ease even in a complicated shape, i.e., covering the coil component 20A in which the coil 2, the inner core portion 31, and the heat dissipating pedestal portion 5A are integrated.

(2) When cast molding is employed in which the case 4A is used as a mold assembly, since the magnetic core 3 can be formed simultaneously with the outer core portion 32, smaller number of manufacturing steps is involved, whereby excellent productivity is exhibited.

(3) The inner core portion 31 and the outer core portion 32 can be joined to each other by the resin forming the outer core portion 32. Further, even when the bolts 100 are omitted, the resin forming the outer core portion 32 can join the coil component 20A and the case 4A to each other.

(4) The magnetic characteristic of the outer core portion 32 can be changed easily.

(5) Since the material covering the outer circumference of the coil component 20A (the coil 2) contains the magnetic substance powder, as compared to the situation where the material is solely resin, the thermal conductivity is higher and an excellent heat dissipating characteristic is obtained.

(6) Since the material forming the outer core portion 32 contains the resin, even in the mode where no lid portion 6A is included, the protection from the external environment and mechanical protection of the coil component 20A can be achieved.

### Second Embodiment

With reference to FIGS. 4 and 5, a description will be given of a reactor 1B according to a second embodiment. The basic structure of the reactor 1B according to the second embodiment is similar to that of the reactor 1A according to the first embodiment. A bottomed sleeve-like case 4B stores a coil component 20B in which a coil 2 mainly structured by one sleeve-like coil element, an inner core portion 31 (FIG. 5), and a heat dissipating pedestal portion 5B (FIG. 5) are integrally retained by a resin mold portion 21. The outer circumferential side of the coil component 20B (the coil 2) is covered by an outer core portion 32 made of a composite material containing magnetic substance powder and resin. The main differences of the reactor 1B according to the second embodiment from the first embodiment lie in the shape of the heat dissipating pedestal portion 5B and the disposition state of the heat dissipating pedestal portion 5B and the case 4B. In the following, a description will be given focusing on the differences, and the structures and effects similar to those of the first embodiment will not be described. Note that, FIG. 5 (B) shows the cross section of solely the outer core portion 32, the case 4B, and the heat dissipating pedestal portion 5B.

As shown in FIG. 5, the heat dissipating pedestal portion 5B is a quadrangular plate-like member similarly to the heat dissipating pedestal portion 5A according to the first embodiment, and includes a supporting face 50 formed by curved surfaces and a flat surface conforming to the outer circumferential face of the coil 2 (coil element), and an installation face 50d (the bottom face in FIG. 5 (B)) formed by a flat surface. Since the heat dissipating pedestal portion 5B does not have any fixing hole 51 (FIG. 1 (B)), the corner portions are not projecting, and the heat dissipating pedestal portion 5B has a simpler outer shape than the heat dissipating pedestal portion 5A. Specifically, the end faces are each ]-shaped and the installation face 50d and the side faces 50s are each rectangular, the end faces, the installation face 50d and the side faces 50s each being formed by a flat surface. However, the supporting face 50 includes linear resin grooves 52 provided from one end face to the other end face. Herein, a plurality of resin grooves 52 are provided in parallel from one side face 50s to other side face 50s, whereby the supporting face 50 is in a concave-convex shape. The resin grooves 52 can increase the contact area between the heat dissipating pedestal portion 5B and the resin forming the resin mold portion 21. As a result, the coil 2 and the heat dissipating pedestal portion 5B can be in close contact with each other. As shown in FIG. 5 (B), the resin grooves 52 are packed with the resin forming the resin mold portion 21. Herein, the resin grooves 52 are formed by cutting work. The shape and the number of resin grooves 52 can be selected as appropriate. For example, the resin grooves 52 may be grid-like or curvy and may be provided by one in number. Provision of at least one hole in place of the resin grooves 52 may achieve the similar effect.

Similarly to the case 4A according to the first embodiment, the case 4B is a rectangular parallelepiped-shape container in which a bottom portion 40 and a wall portion 41 are integrally molded. In particular, with the case 4B, as shown in FIG. 5 (B), the bottom portion 40 includes a quadrangular pedestal groove 401 into which the end faces and the side faces 50s of the heat dissipating pedestal portion 5B included in the coil component 20B are partially fitted. By the heat dissipating pedestal portion 5B being partially fitted into the pedestal groove 401, the coil component 20B is positioned in the case 4B and maintained at that position. Herein, the pedestal groove 401 is provided such that the side faces 50s are partially exposed outside the pedestal groove 401 when the heat dissipating pedestal portion 5B is fitted into the pedestal groove 401. The depth of the pedestal groove 401 can be changed as appropriate, and for example, it may be deep enough for the heat dissipating pedestal portion 5B and part of the coil 2 are fitted into. Further, in the heat dissipating pedestal portion 5B, when part of the region (the end faces or the side faces 50s) fitted into the pedestal groove 401 is exposed outside the resin mold portion 21, to be brought into contact with the pedestal groove 401, the metal forming the case 4B and the metal forming the heat dissipating pedestal portion 5B are directly brought into contact with each other. Thus, the heat dissipating characteristic can be enhanced.

When the case 4B is used as a mold assembly and the outer core portion 32 is formed by cast molding, similarly to the first embodiment, the heat dissipating pedestal portion 5B is fitted into the pedestal groove 401 of the case 4B to be positioned in the case 4B. In this state, the raw material mixture of the outer core portion 32 is packed into the case 4B, and the resin is cured. On the other hand, when the outer core portion 32 is to be a mold product made of the composite material separately produced, the composite material should be molded such that the region in the heat dissipating pedestal portion 5B fitted into the pedestal groove 401 is exposed when the composite material (mold product) is assembled.

In connection with the reactor 1B according to the second embodiment, since the portion in the heat dissipating pedestal portion 5B covering the outer circumferential face of the coil 2 is in a concave-convex shape, the coil 2 and the heat dissipating pedestal portion 5B can be closely brought into contact with each other by the resin mold portion 21, whereby the heat of the coil 2 can be efficiently transferred to the installation target via the heat dissipating pedestal portion 5B. Further, with the reactor 1B, since the heat dissipating pedestal portion 5B is fitted into the bottom portion 40 of the case 4B and the heat dissipating pedestal portion 5B and the case 4B are integrated thereby, the heat from the coil can be further efficiently transferred from the heat dissipating pedestal portion 5B to the outside of the case 4B. Accordingly, the reactor 1B has a further excellent heat dissipating characteristic. Further, with the reactor 1B, the heat dissipating pedestal portion 5B can be positioned in the case 4B without the necessity of using the bolts 100 (FIG. 1), whereby excellent assemblability is exhibited. Further, since the outer shape of the heat dissipating pedestal portion 5B is in a simple shape, the shape of the pedestal groove 401 is also simple. Thus, as compared to the situation where the groove conforming to the outer shape of the coil 2 are formed at the bottom portion of the case, the pedestal groove 401 can be formed easier. Accordingly, with the reactor 1B, excellent productivity of the case 4B is also exhibited.

In addition, the reactor 1B according to the second embodiment also has a quadrangular plate-like lid portion 6B covering the opening portion of the case 4B. The difference of the lid portion 6B from the lid portion 6A included in the reactor 1A according to the first embodiment lies in provision of wire cutouts 61 in place of the wire holes 60 (FIG. 2). In this manner, the specification of the lid portion 6B can also be changed as appropriate.

### Third Embodiment

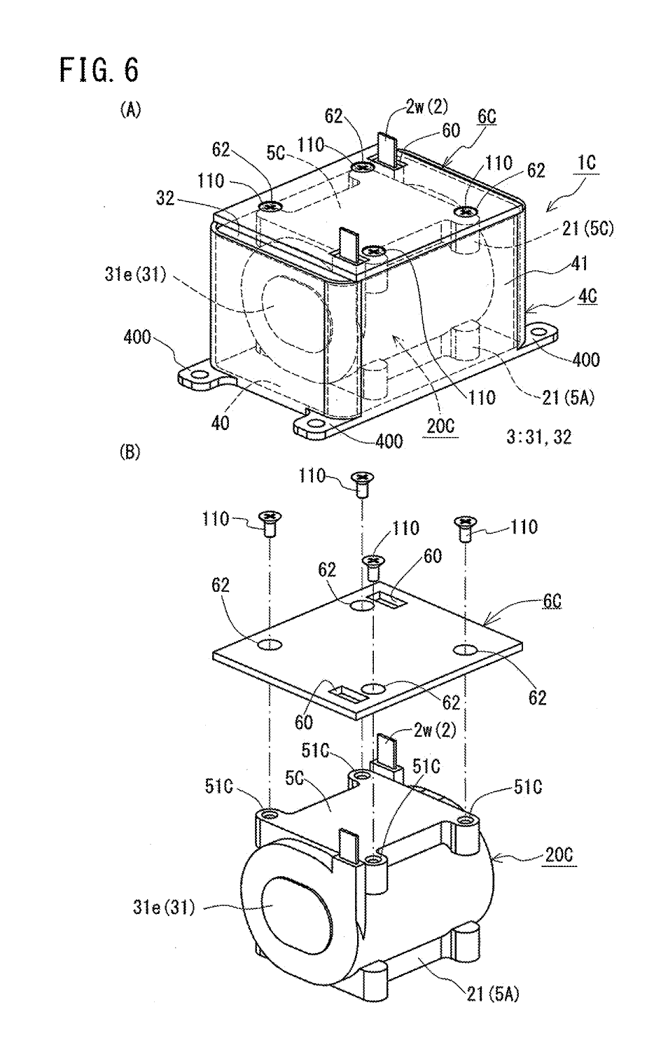

With reference to FIG. 6, a description will be given of a reactor 1C according to a third embodiment. The basic structure of the reactor 1C according to the third embodiment is similar to the reactor 1A according to the first embodiment. A bottomed sleeve-like case 4C stores a coil component 20C in which a coil 2 mainly structured by one sleeve-like coil element, an inner core portion 31, a heat dissipating pedestal portion 5A are integrally retained by a resin mold portion 21. The outer circumferential side of the coil component 20C (the coil 2) is covered by an outer core portion 32 made of a composite material containing magnetic substance powder and resin. Further, the reactor 1C also includes a quadrangular plate-like lid portion 6C covering the opening portion of the case 4C. The main difference of the reactor 1C according to the third embodiment from the first embodiment lies in provision of a lid-side pedestal portion 5C, in addition to the heat dissipating pedestal portion 5A. In the following, a description will be given focusing on the difference, and the structures and effects similar to those of the first embodiment will not be described.

The lid-side pedestal portion 5C is similar to the heat dissipating pedestal portion 5A described in the section of the first embodiment, and the difference only lies in the disposition position. That is, the lid-side pedestal portion 5C is also made of a non-magnetic metal material, and includes a supporting face conforming to the outer circumferential face of the coil 2. Then, the lid-side pedestal portion 5C is disposed to oppose to the heat dissipating pedestal portion 5A with reference to the axis of the coil 2. The lid-side pedestal portion 5C is integrally retained with the coil 2 by the resin mold portion 21. Accordingly, the coil 2, the heat dissipating pedestal portion 5A, the lid-side pedestal portion 5C, and the inner core portion 31 are integrated by the resin mold portion 21, to form the coil component 20C included in the reactor 1C.

When the coil component 20C is stored in the case 4C, the position of the pedestal portions 5A and 5C relative to the coil 2 is retained by the resin mold portion 21 such that, in the outer circumferential face of the coil 2; the heat dissipating pedestal portion 5A is disposed on the installation side (the bottom side in FIG. 6); the lid-side pedestal portion 5C is disposed on the opening side of the case 4C (the top side in FIG. 6); and the face (the top face in FIG. 6 (B)) opposite to the supporting face of the lid-side pedestal portion 5C is directed upward. Then, with the reactor 1C, the lid portion 6C is attached by bolts 110 so as to be brought into contact with the face of the lid-side pedestal portion 5C opposing to the supporting face. With the lid-side pedestal portion 5C, the fixing holes 51 (FIG. 1 (B)) included in the heat dissipating pedestal portion 5A are used as fixing holes 51C to which the bolts 110 are attached for fixing the lid portion 6C.

Similarly to the lid portion 6A included in the reactor 1A according to the first embodiment, the lid portion 6C also includes wire holes 60 into which the end portions of the wire 2w are inserted. The lid portion 6C further includes bolt holes 62 into which the bolts 110 are inserted. Since the lid portion 6C includes the bolt holes 62, projecting pieces with bolt holes are not required, in contrast to the lid portion 6A included in the reactor 1A according to the first embodiment and the lid portion 6B included in the reactor 1B according to the second embodiment. Thus, the lid portion 6C is in a simple shape. Further, with the reactor 1C, since the lid portion 6C is attached to the lid-side pedestal portion 5C as described above, the case 4C does not require the lid pedestal 406 (FIG. 1), and hence is in a simple shape.

The reactor 1C according to the third embodiment includes, in addition to the heat dissipating pedestal portion 5A, the lid-side pedestal portion 5C made of a material exhibiting excellent thermal conductivity. Since the lid portion 6C is fixed to the lid-side pedestal portion 5C, both the lid-side pedestal portion 5C and the lid portion 6C can be used as heat dissipation paths. Thus, the heat of the coil 2 can be transferred outside the case 4C. Accordingly, the reactor 1C can enhance the heat dissipating characteristic of the region on the opening side of the case 4C, whereby a further excellent heat dissipating characteristic can be achieved. Further, since the reactor 1C includes the coil component 20C as a constituent element in which the lid-side pedestal portion 5C also is integrally retained with the coil 2 by the resin mold portion 21, an increase in the number of the assembled components is not invited, and hence excellent assemblability is exhibited. Further, since the resin forming the resin mold portion 21 is interposed between the coil 2 and the lid-side pedestal portion 5C, an excellent insulation performance is also exhibited.

Note that, when the coil component 20C is molded, the resin mold portion 21 is formed such that the installation face 50d of the heat dissipating pedestal portion 5A (FIG. 1 (B)) and the contact face of the lid-side pedestal portion 5C relative to the lid portion 6C (the face opposite to the supporting face) are exposed outside the resin mold portion 21. Further, the matters as to the heat dissipating pedestal portion (surface roughening treatment, application of grease or an adhesive agent) can be applied also to the lid-side pedestal portion 5C.

### Fourth Embodiment

In the sections of the first to third embodiments, the description has been given of the mode in which the inner core portion 31 is made of the powder magnetic core and the outer core portion 32 solely is made of the composite material. It is also possible to employ the mode in which the inner core portion is also made of the composite material containing magnetic substance powder and resin, i.e., the mode in which the entire magnetic core is made of the composite material. In this situation, for example, the inner core portion and the outer core portion may be made of an identical composite material. In this situation, the content of the magnetic substance powder of the composite material forming the core portions may be 40 volume percent or more and 70 volume percent or less; the saturation magnetic flux density may be 0.6 T or more; the relative permeability may be 5 or more and 50 or less, preferably 10 or more and 30 or less; and the relative permeability of the entire magnetic core may be 5 or more and 50 or less. Further, in this situation, the inner core portion and the outer core portion may be integrally molded using the case as a mold assembly, or each may be formed a mold product made of the composite material.

Alternatively, the inner core portion and the outer core portion may be made of different composite materials. With this structure, for example, when the same magnetic substance powder is used, the saturation magnetic flux density or the relative permeability can be adjusted just by changing the content of the magnetic substance powder. Thus, it is advantageous also in that the composite material of any desired characteristic can be easily manufactured. In a specific mode, the inner core portion and the outer core portion are respectively formed by composite materials differing in the material or content of the magnetic substance powder, and the saturation magnetic flux density of the inner core portion is high while and the relative permeability of the outer core portion is low as in the first to third embodiments, or conversely, the relative permeability of the inner core portion is low and the saturation magnetic flux density of the outer core portion is high. Increasing the blending amount of the magnetic substance powder, the composite material with high saturation magnetic flux density and high relative permeability can be obtained easily. On the other hand, reducing the blending amount, the composite material with low saturation magnetic flux density and low relative permeability can be obtained easily. It is also possible to separately prepare columnar composite materials (mold products) by the raw material of the desired composition in advance, and the columnar composite materials can be used as the inner core portion and the outer core portion. The composite material forming each of the inner core portion and the outer core portion may have the following properties: the content of the magnetic substance powder is 40 volume percent or more and 70 volume percent or less; the saturation magnetic flux density is 0.6 T or more; the relative permeability is 5 or more and 50 or less; and preferably 10 or more and 30 or less. The relative permeability of the magnetic core as a whole may be 5 or more and 50 or less.

### Fifth Embodiment

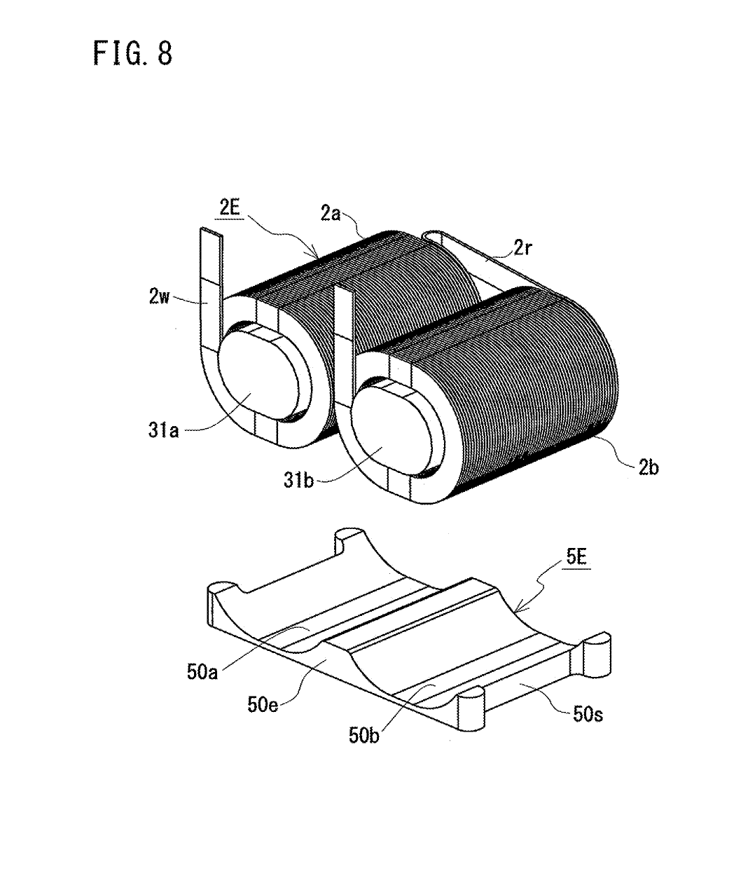

In the sections of the first to fourth embodiments, the description has been given of the mode in which one coil element is included. In other possible mode, as coils 2D and 2E shown in FIGS. 7 and 8, a pair of coil elements 2a and 2b made of a spirally wound wire 2w may be included. The main difference between the coils 2D and 2E lies in the end face shape. The end face shape of the coil elements 2a and 2b of the coil 2D shown in FIG. 7 is quadrangular whose corner portions are rounded. The end face shape of the coil elements 2a and 2b of the coil 2E shown in FIG. 8 is a racetrack shape, as in the first embodiment.

A pair of coil elements 2a and 2b included in each of the coils 2D and 2E respectively shown in FIGS. 7 and 8 is juxtaposed (paralleled) such that the axes of the coil elements 2a and 2b are parallel to each other. The coil elements 2a and 2b are coupled to each other by a couple portion 2r formed by a portion of the wire 2w being folded back. It is also possible to employ the mode in which the coil elements 2a and 2b are made from separate wires, and the one end portions of the wires respectively forming the coil elements 2a and 2b are joined by welding such as TIG welding, fixation under pressure, soldering and the like. In other possible mode, the one end portions are joined to each other via a separately prepared coupling member. Then, for example, in the horizontal storage mode, what is formed is a coil component in which heat dissipating pedestal portion 5D or 5E, on which the installation side face of each of the juxtaposed coil elements 2a and 2b can be disposed, is integrally retained by a resin mold portion (not shown). The heat dissipating pedestal portions 5D and 5E may each be a member that has E-shaped ends and that includes supporting faces 50a and 50b conforming to the outer circumferential face of the coil elements 2a and 2b. Herein, though the mode in which one heat dissipating pedestal portion 5D or 5E is provided for a pair of coil elements 2a and 2b is shown, it is also possible to employ the mode in which two heat dissipating pedestal portions, i.e., a heat dissipating pedestal portion having the supporting face 50a and a heat dissipating pedestal portion having the supporting face 50b are provided. When a pair of coil elements 2a and 2b is included, employing the horizontal storage mode, an excellent heat dissipating characteristic is exhibited. Furthermore, the coil component can be disposed in the case in a stable manner without being hindered by the couple portion 2r.

In the situation where the two coil elements 2a and 2b are included also, it is possible to employ the mode in which the inner core portion is formed by the powder magnetic core and the outer core portion is formed by the composite material, as in the first embodiment. In this situation, as shown in FIGS. 7 and 8, a pair of inner core portions 31a and 31b respectively inserted and disposed into the coil elements 2a and 2b is prepared. Further, in this situation, the outer core portion may be molded by using the case as a mold assembly as in the first embodiment. Alternatively, as the outer core portion, a mold product made of the composite material molded into any appropriate shape (e.g., a rectangular parallelepiped-shape) may be assembled. In other possible mode, in the situation where the two coil elements 2a and 2b are included also, a lid-side pedestal portion may be included as in the third embodiment. Similarly to the heat dissipating pedestal portions 5D and 5E, when the lid-side pedestal portion has a supporting face conforming to the outer circumferential face of the coil elements 2a and 2b, a reactor exhibiting a further excellent heat dissipating characteristic can be structured.

### Sixth Embodiment

In the situation where the two coil elements 2a and 2b are included also, as in the fourth embodiment, the magnetic core may be wholly made of the composite material. In this situation, the inner core portions disposed in the coil elements 2a and 2b may each be a mold product made of the composite material, while the outer core portion disposed outside the coil elements 2a and 2b may be molded using the case as a mold assembly as in the first embodiment. Alternatively, the inner core portions and the outer core portion may each be a mold product made of the composite material. The inner core portions and the outer core portion can be made of the same composite material. In this situation, the content of the magnetic substance powder of the composite material forming the core portions may be 40 volume percent or more and 70 volume percent or less; the saturation magnetic flux density may be 0.6 T or more; and the relative permeability may be 5 or more and 50 or less, preferably 10 or more and 30 or less. The relative permeability of the magnetic core as a whole may be 5 or more and 50 or less. Further, in this situation, when both the inner core portions and the outer core portion are integrally molded using the case as a mold assembly, the assembling work can be omitted.

Alternatively, the inner core portions and the outer core portion may be made of different composite materials. With this structure, for example, when the same magnetic substance powder is used, the saturation magnetic flux density or the relative permeability can be adjusted just by changing the content of the magnetic substance powder. Thus, it is advantageous also in that the composite material of any desired characteristic can be easily manufactured. Adjusting the material or content of the magnetic substance powder, for example, the mode in which the saturation magnetic flux density of the inner core portions is high and the relative permeability of the outer core portion is low, or the mode in which the relative permeability of the inner core portions is low and the saturation magnetic flux density of the outer core portion is high can be achieved. The composite material forming each of the inner core portions and the outer core portion may have the following properties: the content of the magnetic substance powder is 40 volume percent or more and 70 volume percent or less; the saturation magnetic flux density is 0.6 T or more; the relative permeability is 5 or more and 50 or less, preferably 10 or more and 30 or less. The relative permeability of the magnetic core as a whole may be 5 or more and 50 or less. In this situation, excellent manufacturability is exhibited when the inner core portions and the outer core portion are each a mold product made of the composite material.

[Variation 1]

In the section of the first embodiment, though the description has been given of the horizontal storage mode, the vertical disposition mode can be employed in each of the first to sixth embodiments. With the vertical disposition mode, the contact area relative to the installation target can be reduced easier, and a reduction in size of the installation area can be achieved.

With the vertical disposition mode, for example, the magnetic core in the following mode is formed. One end face of the inner core portion projects from one end face of the coil to be brought into contact with the inner bottom face of the case. The outer circumferential face on one end face side of the inner core portion projecting from the coil and other end face of the inner core portion are in contact with the composite material forming the outer core portion. The heat dissipating pedestal portion is, for example as in the first embodiment, a plate-like member having a supporting face conforming to the outer circumferential face of the coil, and the face of the plate-like member opposite to the supporting face may serve as the contact face relative to the wall portion of the case. The end face of the heat dissipating pedestal portion may serve as the installation face to be brought into contact with the inner bottom face of the case. Further, as in the third embodiment, a pair of such heat dissipating pedestal portions may be included and disposed such that the coil is interposed therebetween. Then, the contact face of the wall portion of each of the heat dissipating pedestal portions may be brought into contact with the opposing wall portion of the quadrangular case. In other possible mode, the heat dissipating pedestal portion may be rod-like, plate-like, or L-shaped, for example, and may be disposed only on the one end face side of the coil. In this case, the shape and number of pieces of the heat dissipating pedestal portion and the shape of the resin mold portion may be selected as appropriate such that the magnetic flux can fully pass between the inner core portion and the outer core portion.

[Variation 2]

In the section of the first embodiment, the description has been given of the coil component in which the inner core portion 31 also is integrated. On the other hand, the first to sixth embodiments may each employ the mode in which the coil component has no inner core portion 31, 31a, or 31b. That is, the coil and the heat dissipating pedestal portion may be retained by the resin mold portion, and the coil component may have a hollow hole into which the inner core portion 31, 31a, or 31b is inserted and disposed. In manufacturing the coil component, the core may be used in place of the inner core portion 31 described above. Further, forming the hollow hole by adjusting the thickness of the resin provided inside the coil 2 (the coil element), the resin can be used for positioning the inner core portion 31, 31a, or 31b.

### Seventh Embodiment

The reactor according to any of the first to sixth embodiments and Variations 1 and 2 may be used, for example, as a constituent component of a converter mounted on a vehicle or the like, or as a constituent component of a power converter apparatus including the converter.

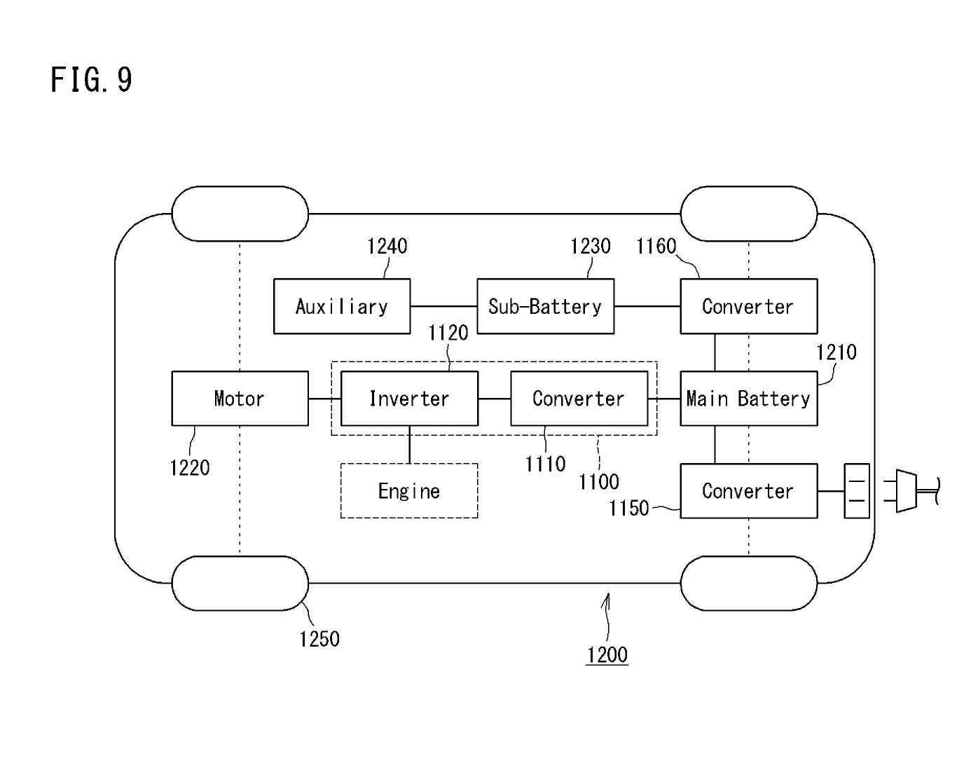

For example, as shown in FIG. 9, a vehicle 1200 such as a hybrid vehicle or an electric vehicle includes a main battery 1210, a power converter apparatus 1100 connected to the main battery 1210, and a motor (load) 1220 driven by power supplied from the main battery 1210 and serves for traveling. The motor 1220 is representatively a three-phase alternating current motor. The motor 1220 drives wheels 1250 in the traveling mode and functions as a generator in the regenerative mode. When the vehicle is a hybrid vehicle, the vehicle 1200 includes an engine in addition to the motor 1220. Though an inlet is shown as a charging portion of the vehicle 1200 in FIG. 9, a plug may be included.

The power converter apparatus 1100 includes a converter 1110 connected to the main battery 1210 to convert an input voltage, and an inverter 1120 connected to the converter 1110 to perform interconversion between direct current and alternating current. When the vehicle 1200 is in the traveling mode, the converter 1110 in this example steps up DC voltage (input voltage) of approximately 200 V to 300 V of the main battery 1210 to approximately 400 V to 700 V, and supplies the inverter 1120 with the stepped up power. Further, in the regenerative mode, the converter 1110 steps down DC voltage (input voltage) output from the motor 1220 through the inverter 1120 to DC voltage suitable for the main battery 1210, such that the main battery 1210 is charged with the DC voltage. When the vehicle 1200 is in the traveling mode, the inverter 1120 converts the direct current stepped up by the converter 1110 to a prescribed alternating current, and supplies the motor 1220 with the converted power to drive the motor 1220. In the regenerative mode, the inverter 1120 converts the AC output from the motor 1220 into direct current, and outputs the direct current to the converter 1110.

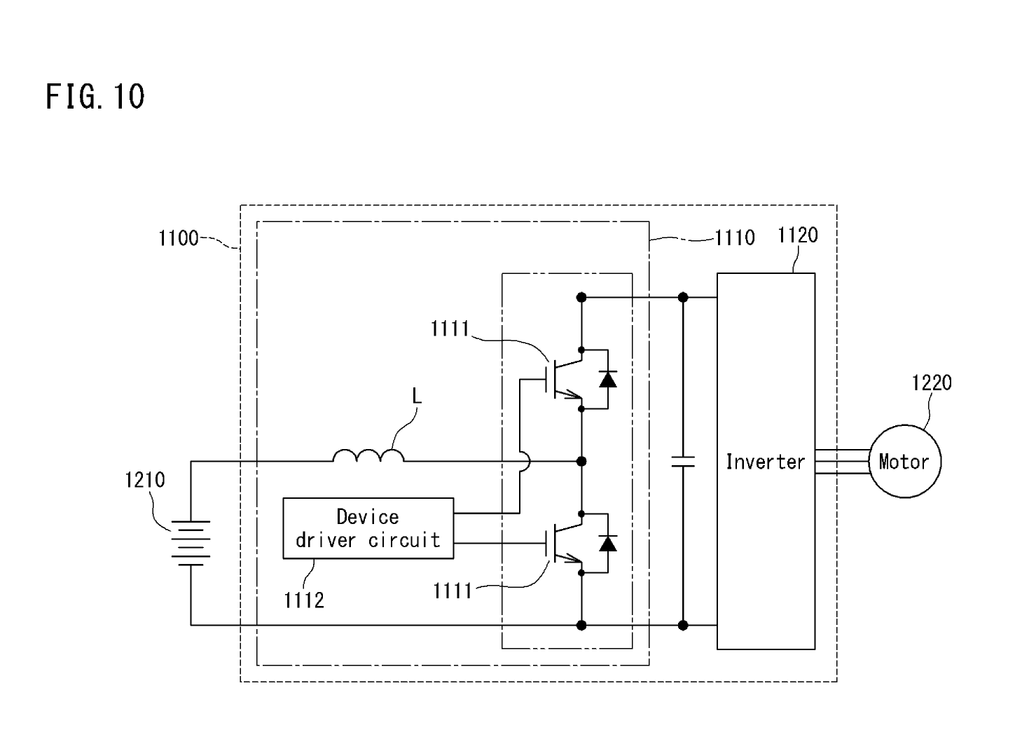

As shown in FIG. 10, the converter 1110 includes a plurality of switching elements 1111, a driver circuit 1112 that controls operations of the switching elements 1111, and a reactor L. The converter 1110 converts (here, performs step up and down) the input voltage by repetitively performing ON/OFF (switching operations). As the switching elements 1111, power devices such as FETs and IGBTs are used. The reactor L uses a characteristic of a coil that disturbs a change of current which flows through the circuit, and hence has a function of making the change smooth when the current is increased or decreased by the switching operation. The reactor L is the reactor according to any of the first to sixth embodiments and Variations 1 and 2. Since the reactor with excellent heat dissipating characteristic is included, the power converter apparatus 1100 and the converter 1110 also exhibit excellent heat dissipating characteristic.

The vehicle 1200 includes, in addition to the converter 1110, a power supply apparatus-use converter 1150 connected to the main battery 1210, and an auxiliary power supply-use converter 1160 connected to a sub-battery 1230 serving as a power supply of auxiliary equipment 1240 and to the main battery 1210, to convert a high voltage of the main battery 1210 to a low voltage. The converter 1110 representatively performs DC-DC conversion, whereas the power supply apparatus-use converter 1150 and the auxiliary power supply-use converter 1160 perform AC-DC conversion. Some types of the power supply apparatus-use converter 1150 perform DC-DC conversion. The power supply apparatus-use converter 1150 and the auxiliary power supply-use converter 1160 each may be structured similarly to the reactor according to the first to sixth embodiments and Variations 1 and 2, and the size and shape of the reactor may be changed as appropriate. Further, the reactor according to any of the foregoing first and sixth embodiments and Variations 1 to 2 may be used as a converter that performs conversion for the input power and that performs only stepping up or stepping down.

Note that the present invention is not limited to the embodiments described above, and can be practiced as being modified as appropriate within a range not departing from the gist of the present invention.

For example, it is possible to employ the mode in which the sealing resin is interposed between the coil and the heat dissipating pedestal portion, in addition to the resin forming the resin mold portion, or the mode in which the coil and the heat dissipating pedestal portion are integrated by the sealing resin. In these modes, since the relative position between the coil and the heat dissipating pedestal portion can be maintained by the sealing resin that is present at least between the coil and the heat dissipating pedestal portion, the heat of the coil can be transferred to the heat dissipating pedestal portion in an excellent manner. Further, subjecting the heat dissipating pedestal portion to the surface roughening treatment, the contact area between the sealing resin and the heat dissipating pedestal portion can be increased, and the heat dissipating characteristic can be further enhanced. In other possible mode, when the magnetic core is a mold product formed by the composite material or the powder magnetic core, the magnetic core can be assembled to the coil with ease. Therefore, the resin mold portion may be dispensed with, and the coil, the magnetic core, and the heat dissipating pedestal portion may be fixed to one another by an adhesive agent, or they may be stored in the case and thereafter fixed by a sealing resin or the like as described above.

### INDUSTRIAL APPLICABILITY

The reactor of the present invention can be used as a constituent component of a power converter apparatus, such as a DC-DC converter mounted on a vehicle such as a hybrid vehicle, a plug-in hybrid vehicle, an electric vehicle, and a fuel cell vehicle, and a converter of an air conditioner. The reactor-use coil component of the present invention can be used as a constituent component of the reactor used for the power converter apparatus.

### REFERENCE SIGNS LIST

1A, 1B, 1C: REACTOR
2, 2D, 2E: COIL
2w: WIRE
2a, 2b: COIL ELEMENT
2r: COUPLE PORTION
20A, 20B, 20C: COIL COMPONENT
21: RESIN MOLD PORTION
3: MAGNETIC CORE
31, 31a, 31b: INNER CORE PORTION
31e: END FACE
32: OUTER CORE PORTION
4A, 4B, 4C: CASE
40: BOTTOM PORTION
40o: OUTER BOTTOM FACE
41: WALL PORTION
400: ATTACHING PORTION
401: PEDESTAL GROOVE
406: LID PEDESTAL
5A, 5B, 5D, 5E: HEAT DISSIPATING PEDESTAL PORTION
5C: LID-SIDE PEDESTAL PORTION
50, 50a, 50b: SUPPORTING FACE
50d: INSTALLATION FACE
50s: SIDE FACE
50e: END FACE
51, 51C: FIXING HOLE
52: RESIN GROOVE
6A, 6B, 6C LID PORTION
60: WIRE HOLE
61: WIRE CUTOUT
62: BOLT HOLE
100, 110: BOLT
1100: POWER CONVERTER APPARATUS
1110: CONVERTER
1111: SWITCHING ELEMENT
1112: DRIVER CIRCUIT
L: REACTOR
1120: INVERTER
1150: POWER SUPPLY APPARATUS-USE CONVERTER
1160: AUXILIARY POWER SUPPLY-USE CONVERTER
1200: VEHICLE
1210: MAIN BATTERY
1220: MOTOR
1230: SUB-BATTERY
1240: AUXILIARY EQUIPMENT
1250: WHEELS

1. A reactor comprising:
a sleeve-like coil;
a magnetic core that is disposed inside and outside the coil to form a closed magnetic path; and
a case that stores the coil and the magnetic core, wherein
at least part of the magnetic core is formed by a composite material that contains magnetic substance powder and resin, the reactor further comprising:
a resin mold portion that is formed by an insulating resin and that covers at least part of an outer circumference of the coil to retain a shape of the coil; and
a heat dissipating pedestal portion that is formed by a non-magnetic metal material and that is integrally retained with the coil by the resin forming the resin mold portion to form at least part of the case.

2. The reactor according to claim 1, wherein
the coil includes a juxtaposed pair of sleeve-like coil elements, and
the magnetic core is formed by the composite material.

3. The reactor according to claim 1, wherein
the coil includes the sleeve-like coil element by one in number,
in the magnetic core, at least part of a portion disposed on an outer circumferential side of the coil element is formed by the composite material, and
in the outer circumference of the coil element, a portion covered by the composite material is covered by the resin forming the resin mold portion.

4. The reactor according to claim 1, wherein
in the heat dissipating pedestal portion, at least part of a region covered by the resin mold portion is subjected to a surface roughening treatment.

5. The reactor according to claim 1, wherein
the heat dissipating pedestal portion has a fixing hole with which a fastening member for fixing the heat dissipating pedestal portion to the case is screwed.

6. The reactor according to claim 1, wherein
the case and the heat dissipating pedestal portion each include an engaging portion engaging with each other.

7. The reactor according to claim 6, wherein
at the case, a pedestal groove into which at least part of the heat dissipating pedestal portion is fitted is formed.

8. The reactor according to claim 1, further comprising:
a lid portion that covers an opening portion of the case; and
a lid-side pedestal portion that is formed by a non-magnetic metal material and that is integrally retained with the coil by the resin forming the resin mold portion, the lid portion being attached to the lid-side pedestal portion.

9. The reactor according to claim 1, wherein
in the magnetic core, an inner core portion disposed inside the coil is integrally retained with the coil by the resin forming the resin mold portion.

10. The reactor according to claim 1, wherein
the coil is stored in the case such that an axis of the coil is parallel to an outer bottom face of the case.

11. The reactor according to claim 1, wherein
the heat dissipating pedestal portion includes a supporting face that conforms to an outer circumferential face of the coil.

12. A converter comprising the reactor according to claim 1.

13. A power converter apparatus comprising the converter according to claim 12.

14. A reactor-use coil component used for a reactor including a sleeve-like coil and a magnetic core disposed inside and outside the coil to form a closed magnetic path, and a case storing the coil and the magnetic core, the reactor-use coil component comprising:
a sleeve-like coil;
a resin mold portion that is formed by an insulating resin, and that covers at least part of an outer circumference of the coil to retain a shape of the coil; and
a heat dissipating pedestal portion that is formed by a non-magnetic metal material and that is integrally retained with the coil by the resin forming the resin mold portion to form at least part of the case, wherein
at least part of the magnetic core is formed by a composite material containing magnetic substance powder and resin.
